(19) United States
(12) Patent Application Publication
(10) Pub. No.: US 2008/0071820 A1
(43) Pub. Date: Mar. 20, 2008

(54) Apparatus and method for managing an encapsulated document

(76) Inventors: Masami Mori, Tokyo (JP); Akira Suzuki, Kanagawa (JP); Taiga Asano, Kanagawa (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/894,839

(22) Filed: Aug. 21, 2007

(30) Foreign Application Priority Data
Aug. 21, 2006 (JP) 2006-224522

(51) Int. Cl. G06F 17/30

(52) U.S. Cl. 707/102; 707/101; 707/E17.005

(57) ABSTRACT

An apparatus for managing an encapsulated document is disclosed that includes a file management unit to manage one or more content files; a program management unit to manage one or more programs for causing the content files to be manipulated; a document creation unit to create the encapsulated document by storing a content file selected from the content files managed by the file management unit and a program selected from the programs managed by the program management unit in a single file; an extraction unit to extract information on a manipulation by a user of the content file stored in the encapsulated document, the information being recorded in the encapsulated document by the program stored in the encapsulated document in accordance with the manipulation; and a manipulation information management unit to manage the extracted information on the manipulation.

### PRIORITY

The present application claims priority to and incorporates by reference the entire contents of Japanese patent application, No. 2006-224522, filed in the Japan on Aug. 21, 2006.

### BACKGROUND OF THE INVENTION

1. Field of the Invention

The present invention relates to apparatuses and methods for managing an encapsulated document.

2. Description of the Related Art

In a computer system (hereinafter simply referred to as “system”) where electronic documents (files) are stored and provided to users, the files existing in the system can be handled only by users who can access the system. However, it is often the case that a user who can access the system and a user who cannot access the system have to communicate with each other using files in the system.

Usually, the user who can access the system extracts a necessary file from the system, and sends it to the user who cannot access the system using such means as e-mail. However, if there are multiple files to be sent, it is troublesome to extract them from the system and attach them to an e-mail message. In order to save such trouble, International Application Publication No. WO2004/027624 (hereinafter referred to as Patent Document 1) proposes packaging multiple related files into one for easier handling.

However, Patent Document 1 does not go so far as to consider communications between users based on a single packaged file (hereinafter referred to as “package”). Accordingly, when it is necessary to perform communications based on the package, it is required, for example, to give an explanation of attached files in the main body of an e-mail message to which the package is attached or to have only the package sent and communicate by telephone. Nowadays, however, an increasing amount of information handled by a file makes it difficult for a sender of the package to give a to-the-point explanation, so that the sender often fails to give a good explanation of what the sender means and has to repeat explanation over and over again to a receiver.

Therefore, it is believed that it facilitate communicating the intention of the sender to the receiver if it is possible to directly add comments to or revise portions to be paid attention to in files contained in the package.

Accordingly, improvement in the efficiency of file-based communications can be expected if it is possible to not only simply package multiple files but also provide the package with a function (program) for supporting communications through the package.

Techniques for packaging a function (program) and multiple content files into one include that disclosed in Japanese Laid-Open Patent Application No. 2003-99303 (hereinafter referred to as Patent Document 2). This technique makes it possible to add a function for supporting communications to a package and record the contents of communications using the function in the package.

The contents of communication recorded in the package do not form orderly minutes of proceedings, but are the record of a direct exchange between users. Accordingly, for example, in the case where a change or modification has been made to a file contained in the package during its circulation through users, such a record can be effective material when those concerned in the communications later check, confirm, or identify the reason for such a change or modification to the file. Further, “why such a change or modification has been made” can form know-how, and can be a useful asset for not only those concerned in the communications but also, for example, an organization such as an enterprise to which those concerned belong.

### SUMMARY OF THE INVENTION

An apparatus and method for managing an encapsulated document are described. In one embodiment, a file management unit to manage one or more content files; a program management unit to manage one or more programs for causing the content files to be manipulated; a document creation unit to create the encapsulated document by storing a content file selected from the content files managed by the file management unit and a program selected from the programs managed by the program management unit in a single file; an extraction unit to extract information on a manipulation by a user of the content file stored in the encapsulated document, where the information is recorded in the encapsulated document by the program stored in the encapsulated document in accordance with the manipulation; and a manipulation information management unit to manage the extracted information on the manipulation.

### BRIEF DESCRIPTION OF THE DRAWINGS

Other embodiments, features and advantages of the present invention will become more apparent from the following detailed description when read in conjunction with the accompanying drawings, in which:

FIG. 1 is a diagram showing a basic structure of an encapsulated document according to an embodiment of the present invention;

FIG. 2 is a diagram showing a functional configuration of an encapsulated document management apparatus according to the embodiment of the present invention;

FIG. 3 is a diagram showing a configuration of a content table forming a content DB according to the embodiment of the present invention;

FIG. 4 is a diagram showing a configuration of a program table forming a program DB according to the embodiment of the present invention;

FIG. 5 is a block diagram showing a hardware configuration of the encapsulated document management apparatus according to the embodiment of the present invention;

FIG. 6 is a diagram for giving an overview of the embodiment of the present invention;

FIG. 7 is a flowchart for illustrating creation of the encapsulated document in the encapsulated document management apparatus according to the embodiment of the present invention;

FIG. 8 is a diagram showing an example display of a content selection screen according to the embodiment of the present invention;

FIG. 9 is a diagram showing an example display of a function program selection screen according to the embodiment of the present invention;

FIGS. 10A, 10B, and 10C are diagrams showing content display formats according to the embodiment of the present invention;

FIG. 11 is a flowchart for illustrating creation of the encapsulated document by a creation part according to the embodiment of the present invention;

FIG. 12 is a diagram showing a description of a definition file according to the embodiment of the present invention;

FIG. 13 is a diagram showing a configuration of an encapsulated document management table forming an encapsulated document management DB according to the embodiment of the present invention;

FIG. 14 is a flowchart for illustrating selection of target content based on search results according to the embodiment of the present invention;

FIG. 15 is a diagram showing an example display of a search screen according to the embodiment of the present invention;

FIG. 16 is a diagram showing an example display of a search result display screen according to the embodiment of the present invention;

FIG. 17 is a diagram showing an example display of a content file display screen by a GUI part according to the embodiment of the present invention;

FIG. 18 is a sequence diagram for illustrating distribution of the encapsulated document according to the embodiment of the present invention;

FIG. 19 is a flowchart for illustrating execution (activation) of the encapsulated document according to the embodiment of the present invention;

FIG. 20 is a flowchart for illustrating activation of function programs according to the embodiment of the present invention;

FIG. 21 is a diagram conceptually showing example asynchronous communications according to the embodiment of the present invention;

FIG. 22 is a diagram showing a structure of the encapsulated document with a record folder according to the embodiment of the present invention;

FIG. 23 is a diagram showing a configuration of a comment file according to the embodiment of the present invention;

FIG. 24 is a flowchart showing a flow of establishing communications between encapsulated documents according to the embodiment of the present invention;

FIG. 25 is a schematic diagram showing an example of a document identifier code according to the embodiment of the present invention;

FIG. 26 is a flowchart for illustrating a synchronous communication operation according to the embodiment of the present invention;

FIG. 27 is a schematic diagram showing two synchronized encapsulated documents according to the embodiment of the present invention;

FIG. 28 is a table showing a configuration of a manipulation log file according to the embodiment of the present invention;

FIG. 29 is a sequence diagram for illustrating an operation in the case of transmitting manipulation logs from the encapsulated document to the encapsulated document management apparatus according to the embodiment of the present invention;

FIG. 30 is a diagram showing an example display of a manipulation log screen according to the embodiment of the present invention;

FIG. 31 is a flowchart for illustrating an operation at the time when a manipulation log is clicked according to the embodiment of the present invention;

FIG. 32 is a sequence diagram showing the operation from creation up to re-storing (write-back) of the encapsulated document according to the embodiment of the present invention;

FIG. 33 is a flowchart for illustrating re-storing of the encapsulated document according to the embodiment of the present invention;

FIG. 34 is a diagram showing a configuration of a communication table forming a communication DB according to the embodiment of the present invention;

FIG. 35 is a diagram showing an example display of a dialog for confirming whether to authorize registration of the encapsulated document according to the embodiment of the present invention;

FIG. 36 is a diagram showing an example display of content and its manipulation logs according to the embodiment of the present invention; and

FIG. 37 is a diagram showing an example display of a list of content files regarding a user according to the embodiment of the present invention.

### DETAILED DESCRIPTION OF THE PREFERRED EMBODIMENTS

According to one embodiment of the present invention, there are provided an apparatus and method for managing an encapsulated document that are capable of appropriately managing an electronic document having a unit for smoothing communications between users.

According to one embodiment of the present invention, there is provided an apparatus for managing an encapsulated document, the apparatus including a file management unit to manage one or more content files; a program management unit to manage one or more programs for causing the content files to be manipulated; a document creation unit to create the encapsulated document by storing a content file selected from the content files managed by the file management part and a program selected from the programs managed by the program management part in a single file; an extraction unit to extract information on a manipulation by a user on the content file stored in the encapsulated document, the information being recorded in the encapsulated document by the program stored in the encapsulated document in accordance with the manipulation; and a manipulation information management unit to manage the extracted information on the manipulation.

According to one embodiment of the present invention, there is provided a method of managing an encapsulated document executed by a computer, the method including a file management step of managing multiple content files; a program management step of managing multiple programs for causing the content files to be manipulated; a document creation step of creating the encapsulated document by storing a content file selected from the content files managed in the file management step and a program selected from the programs managed in the program management step in a single file; an extraction step of extracting information on a manipulation by a user of the content file stored in the encapsulated document, the information being recorded in the encapsulated document by the program stored in the encapsulated document in accordance with the manipulation; and a manipulation information management step of managing the extracted information on the manipulation.

According to the above-described apparatus and method for managing an encapsulated document, it is possible to manage an electronic document having a part for smoothing communications between users.

Thus, according to embodiments of the present invention, it is possible to provide an apparatus and method for managing an encapsulated document which apparatus and method are capable of appropriately managing an electronic document having a part for smoothing communications between users.

A description is given below, with reference to the accompanying drawings, of an embodiment of the present invention.

[Encapsulated Document]

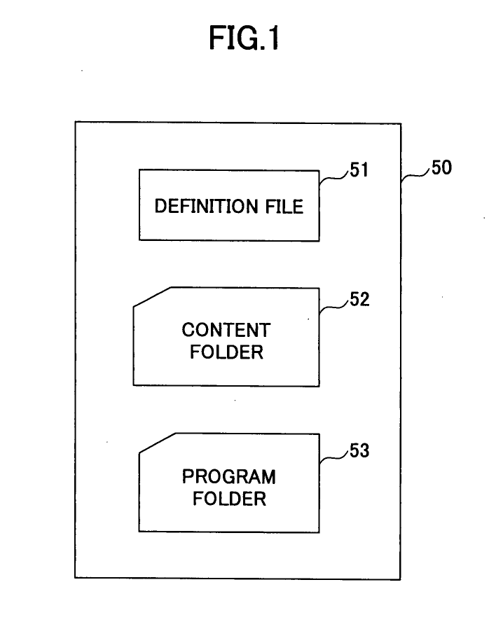

First, a description is given of an encapsulated document employed in the embodiment of the present invention. FIG. 1 is a diagram showing a basic structure of the encapsulated document according to this embodiment.

The encapsulated document is a single file into which multiple files are packaged (encapsulated). The multiple files include files storing data serving as content themselves, such as document data, image data, and audio data (hereinafter referred to as “content files”), and files storing programs for handling the content files (hereinafter referred to as “program files”). In this embodiment, a description is given of a case where a Jar (Java [registered trademark] Archive) file is used as one means for implementing encapsulation. The Jar file format is based on a currently widely-used archive format (ZIP), and is a platform-independent file format that packages multiple files into a single file.

Referring to FIG. 1, an encapsulated document 50 includes a definition file 51, a content folder 52, and a program folder 53. The content folder 52 contains one or more content files. The program folder 53 contains program files for handling the content files contained in the content folder 53. The definition file 51 contains information for handling the encapsulated document 50, such as information showing the configuration of the encapsulated document 50. The definition file 51 is used by programs contained in the program folder 52.

The programs contained in the program folder 52 are roughly divided into a basic program and function programs. There is one basic program in one encapsulated document 50. The basic program is called first at the time of executing (activating) the encapsulated document 50, and starts and controls one or more function programs in accordance with the contents of the definition of the definition file 51. For example, the encapsulated document 50 configured based on the jar file format contains a manifest file (not graphically illustrated), in which the following definition is given:
Manifest-Version: 1.0
Main-Class: AppMain
Created-By: 1.3.1 (RRR Company, LTD.)

Here, the second line indicates the file name of a program having a main function. The program specified here corresponds to the basic program.

Meanwhile, the function programs are for implementing various functions for utilizing the encapsulated document 50. The function programs may include multiple programs in accordance with functions that are desired to be implemented in the encapsulated document 50, such as a function program for implementing the security function of the encapsulated document 50, a function program for displaying or reproducing content contained in a content file, and a function program for implementing the function of inter-user communication through the encapsulated document 50.

Thus, one or more content files and programs for handling the content files are integrated into the encapsulated document 50. Accordingly, a user who receives the encapsulated document 50 during its circulation can handle the content files using the function programs contained in the encapsulated document 50 even in an environment where applications for handling the content files contained in the encapsulated document 50 are not preinstalled. That is, compared with a mere content file, the encapsulated document 50 has merit in that the content is less subject to the difference between user environments during its circulation through users.

[Encapsulated Document Management Apparatus]

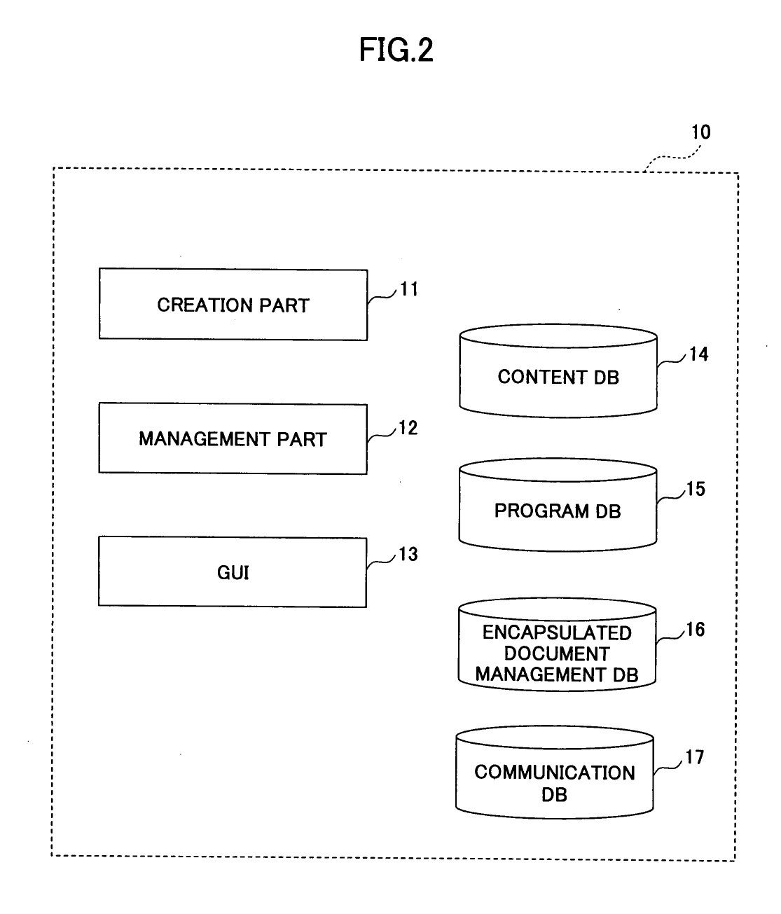

In this embodiment, the encapsulated document 50 is created and managed by an encapsulated document management apparatus. FIG. 2 is a diagram showing a functional configuration of an encapsulated document management apparatus 10 according to this embodiment.

Referring to FIG. 2, the encapsulated document management apparatus 10 includes a creation unit 11, a management unit 12, a GUI (Graphical User Interface) unit 13, a content DB (database) 14, a program DB 15, an encapsulated document management DB 16, and a communication DB 17.

The creation unit 11 creates the encapsulated document 50. The created encapsulated document 50 is registered in the encapsulated document management DB 16.

The management unit 12 extracts (checks out) the encapsulated document 50 from the encapsulated document management DB 16, and re-stores or writes back (checks in) the extracted encapsulated document 50 to the encapsulated document management DB 16.

The GUI unit 13 provides a GUI for receiving a user's inputs such as instructions for the creation unit 11 and the management unit 12 to execute functions.

The content DB 14 is a database in which the attribute information of each content file is recorded.

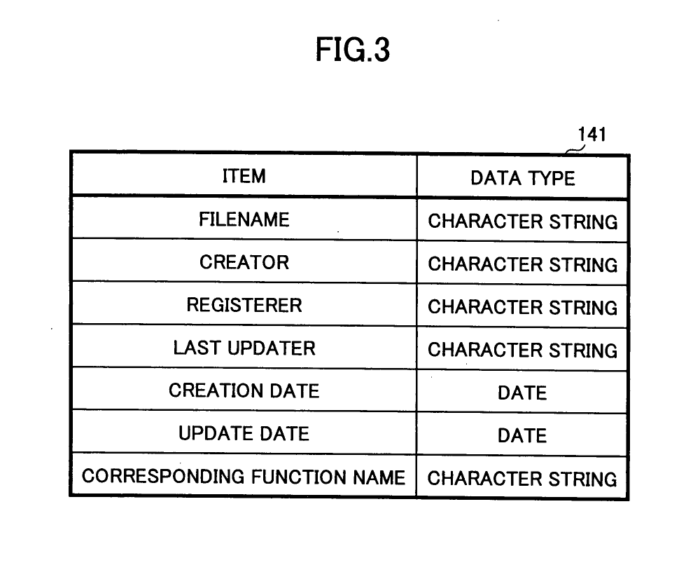

FIG. 3 is a diagram showing a configuration of a content table forming the content DB 14. Referring to FIG. 3, a content table 141 includes items such as Filename, Creator, Registerer, Last Updater, Creation Date, Update Date, and Corresponding Function Name. That is, these attribute information items are stored as records on a content-file basis in the content table 141.

The filename of a content file is recorded in Filename. The storage location of the content file can be specified by the filename. The username of a user who has created the content file is recorded in Creator. The username of a user who has registered the content file in the content file DB 14 is recorded in Registerer. The username of a user who has last updated the content file is recorded in Last Updater. The date of creation and the date of update of the content file are recorded in Creation Date and Update Date, respectively. The function name (program name) of a function program for displaying or reproducing the content file is recorded in Corresponding Function Name. That is, each content file is correlated with a corresponding function program or a function program for displaying or reproducing the content file in the content table 141.

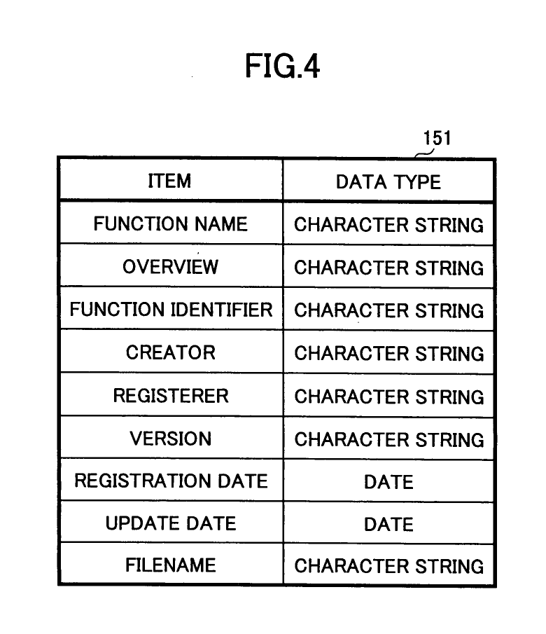

The program DB 15 is a database in which the attribute information of each function program is recorded. FIG. 4 is a diagram showing a configuration of a program table forming the program DB 15. Referring to FIG. 4, a program table 151 includes items such as Function Name, Overview, Function Identifier, Creator, Registerer, Version, Registration Date, Update Date, and Filename. That is, these attribute information items are stored as records on a program-file basis in the program table 151.

The function name of a function program such as “Revision Function” or “Recording Function” is recorded in Function Name. A descriptive text giving an overview of the function of the function program is recorded in Overview. A character string for identifying the function of the function program is recorded in Function Identifier. That is, Function Name and Overview are character strings used mainly for causing a user to identify a function program on a display screen, while Function Identifier is used for a program to identify each function program. The username of a user who has created the program file of the function program is recorded in Creator. The username of a user who has registered the program file in the program DB 15 is recorded in Registerer. The version of the function program is recorded in Version. The date of registration and the date of update of the program file are recorded in Registration Date and Update Date, respectively. The filename of the program file is recorded in Filename. The storage location of the program file of the function program can be specified by the filename.

The encapsulated document management DB 16 is a database that manages the configuration information and the status of each created encapsulated document 50. The communication DB 17 is a database for managing the contents of communications recorded in the encapsulated document 50 during its circulation through users. A description is given below of the details of the encapsulated document management DB 16 and the communication DB 17.

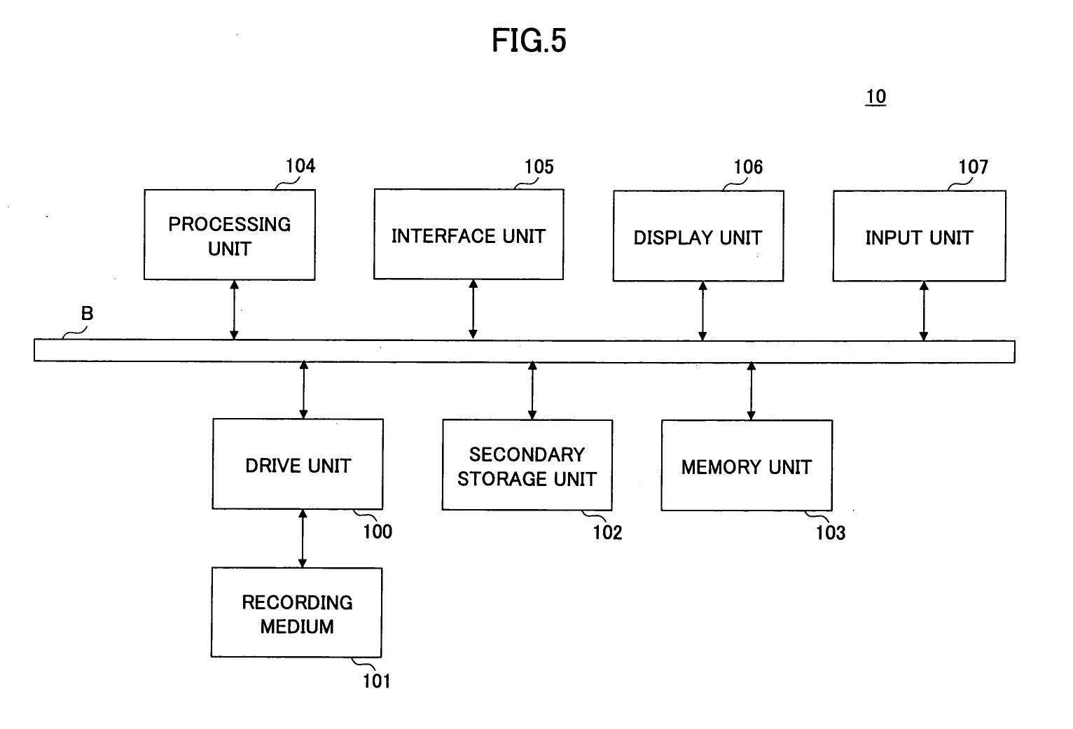

FIG. 5 is a block diagram showing a hardware configuration of the encapsulated document management apparatus 10 according to this embodiment. Referring to FIG. 5, the encapsulated document management apparatus 10 includes a drive unit 100, a secondary storage unit 102, a memory unit 103, a processing unit 104, an interface unit 105, a display unit 106, and an input unit 107, all of which are connected to one another through a bus B.

A program that implements processing in the encapsulated document management apparatus 10 is provided through a recording medium 101 such as a CD-ROM. When the recording medium 101 having a program recorded thereon is loaded into the drive unit 100, the program is installed from the recording medium 101 into the secondary storage unit 102 through the drive unit 100. The secondary storage unit 102 contains the installed program together with a necessary file and data.

The program is read out from the secondary storage unit 102 and stored in the memory unit 103 in response to an instruction to start the program. The processing unit 104 implements one or more functions related to the encapsulated document management apparatus 10 in accordance with the program contained in the memory unit 103. The interface unit 105 is used as an interface for connecting to a network. The display unit 106 displays a GUI by the program. The input unit 107 includes a keyboard and a mouse, and is used for inputting various manipulation instructions.

The program does not necessarily have to be installed from the recording medium 101. Alternatively, the program may be downloaded from another computer through a network.

A description is given below of an operational procedure of the encapsulated document management apparatus 10.

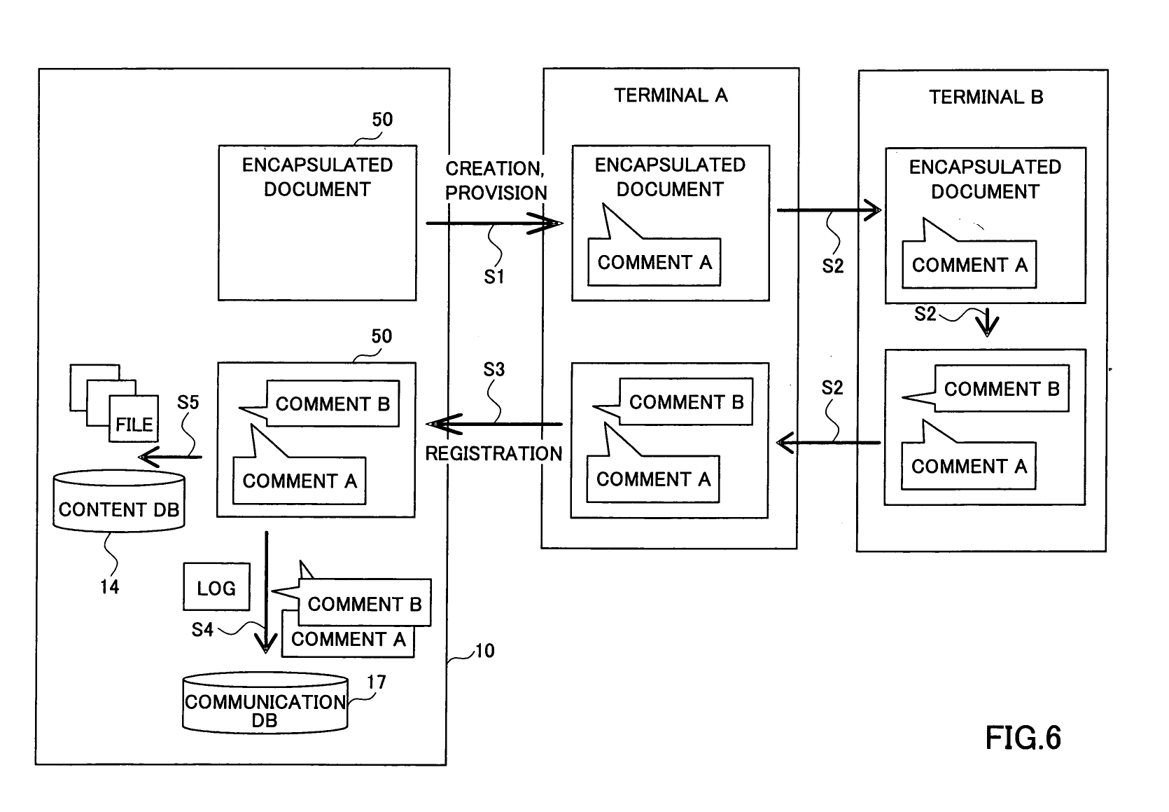

FIG. 6 is a diagram for giving an overview of this embodiment.

In this embodiment, a description is given of a continuous flow from creating the above-described encapsulated document 50 in the encapsulated document management apparatus 10 and providing it in step S1 and performing communications between users (Terminals A and B) through the encapsulated document 50 in step S2 up to re-storing (registering) one or more content files on which various operations (manipulations) such as attaching comments or editing have been performed in the process of the communications in step S3.

At the time of re-storing, the attached comments are recorded in the communication DB 17 in step S4, and one or more content files updated in the encapsulated document 50 are re-stored in the content DB 14 in step S5.

[Creation of Encapsulated Document]

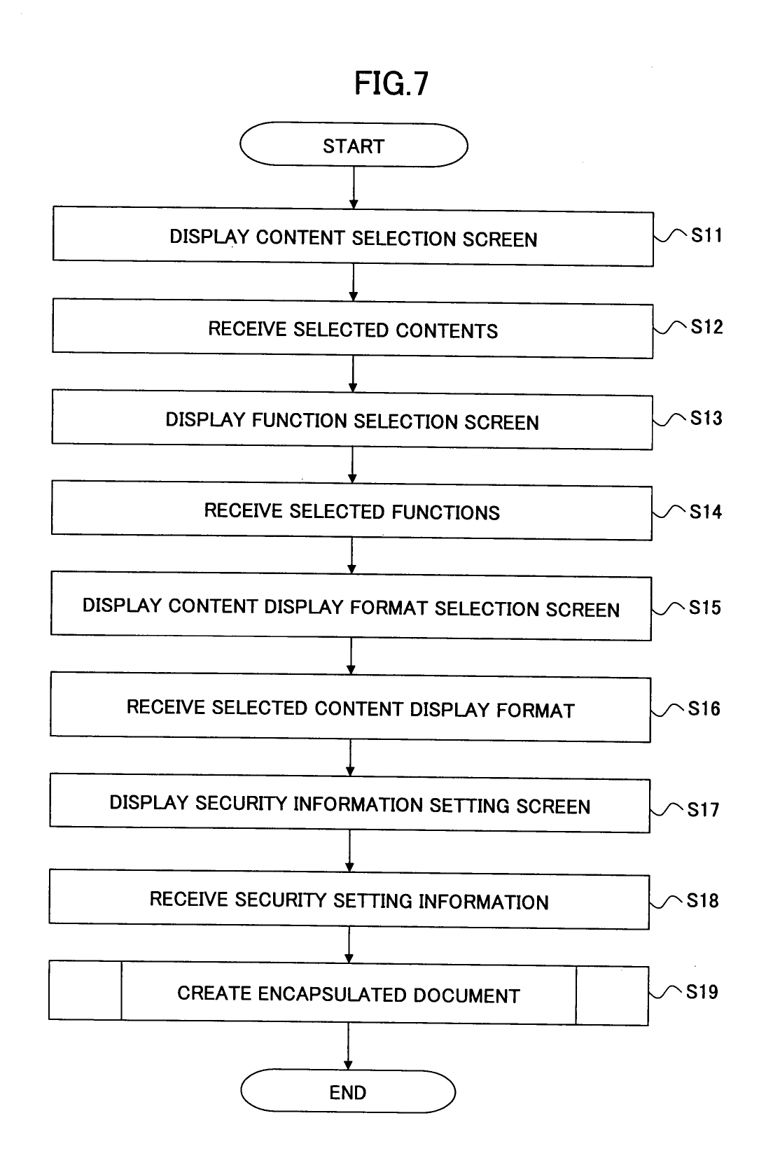

FIG. 7 is a flowchart for illustrating creation of the encapsulated document 50 in the encapsulated document management apparatus 10.

Referring to FIG. 7, when a user inputs an instruction to create the encapsulated document 50 to the encapsulated document management apparatus 10, in step S11, the GUI part 13 causes a screen for selecting a content file to be included in the encapsulated document 50 (hereinafter referred to as “content selection screen”) to be displayed on the display unit 106.

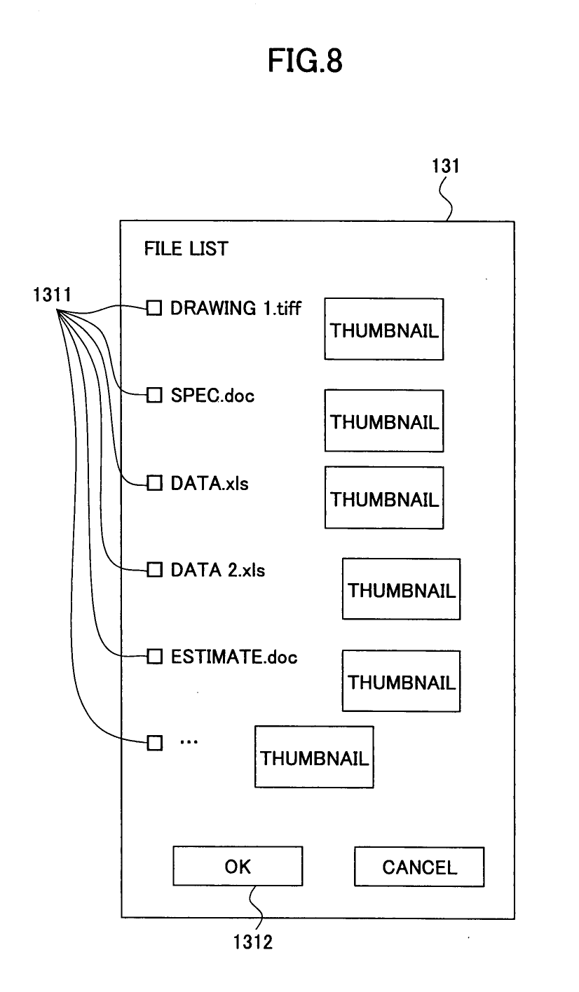

FIG. 8 is a diagram showing an example display of the content selection screen.

Referring to FIG. 8, for example, those of the content files recorded in the content table 141 which a current user is authorized to access are displayed in a list on a content selection screen 131. A filename and a thumbnail image (a reduced image) are displayed for each content file. Further, a check button 1311 is provided for each content file on the content selection screen 131. The user can select or determine a content file to be included in the encapsulated document 50 by selecting the corresponding check button 1311.

When one or more content files are selected and an OK button 1312 is operated on (for example, clicked), in step S12, the GUI part 13 records the filenames of the selected content files in the memory unit 103.

Next, in step S13, the GUI part 13 causes a screen for selecting a function program to be included in the encapsulated document 50 (hereinafter referred to as “function program selection screen”) to be displayed on the display unit 106.

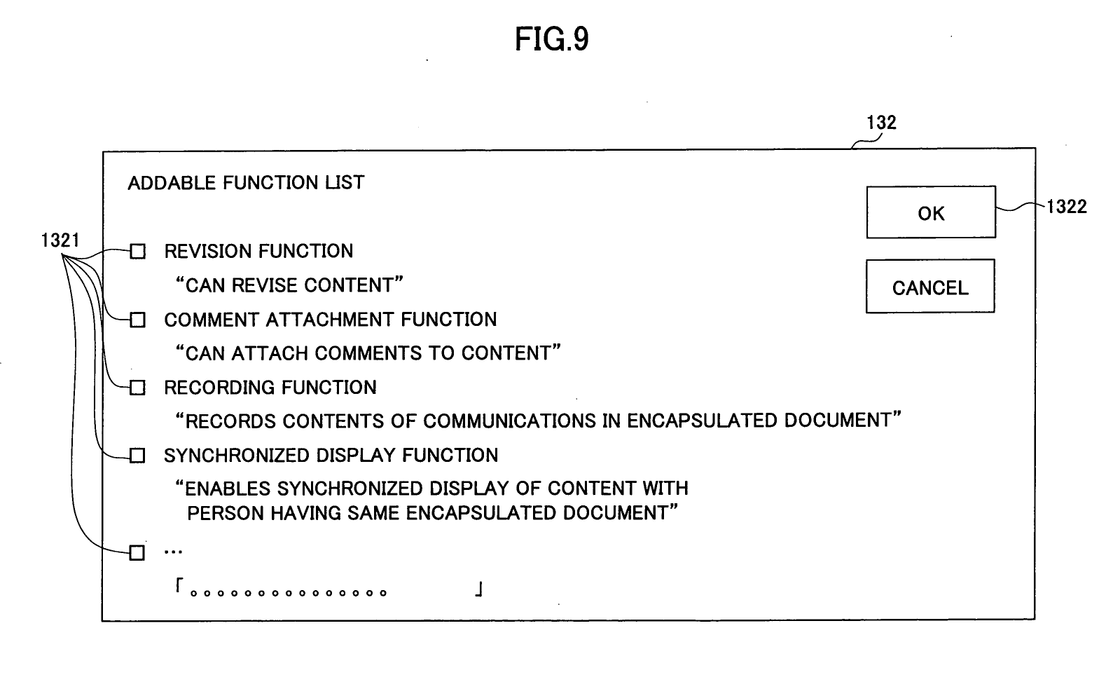

FIG. 9 is a diagram showing an example display of the function program selection screen.

Referring to FIG. 9, the function programs recorded in the program table 151 are displayed in a list on a function program selection screen 132. A function name and an overview are displayed for each function program. Further, a check button 1321 is provided for each function program on the function program selection screen 132. The user can select a function program to be included in the encapsulated document 50 by selecting the corresponding check button 1321.

When one or more function programs are selected and an OK button 1322 is operated on (for example, clicked), in step S14, the GUI part 13 records the function names of the selected function programs in the memory unit 103.

Next, in step S15, the GUI part 13 causes a screen for selecting a content display format for displaying the contents of the encapsulated document 50 to be created (hereinafter referred to as “display format selection screen”) to be displayed on the display unit 106. Here, the content display format refers to the display format of a screen for displaying the contents of multiple content files contained in the encapsulated document 50 when the encapsulated document 50 is executed.

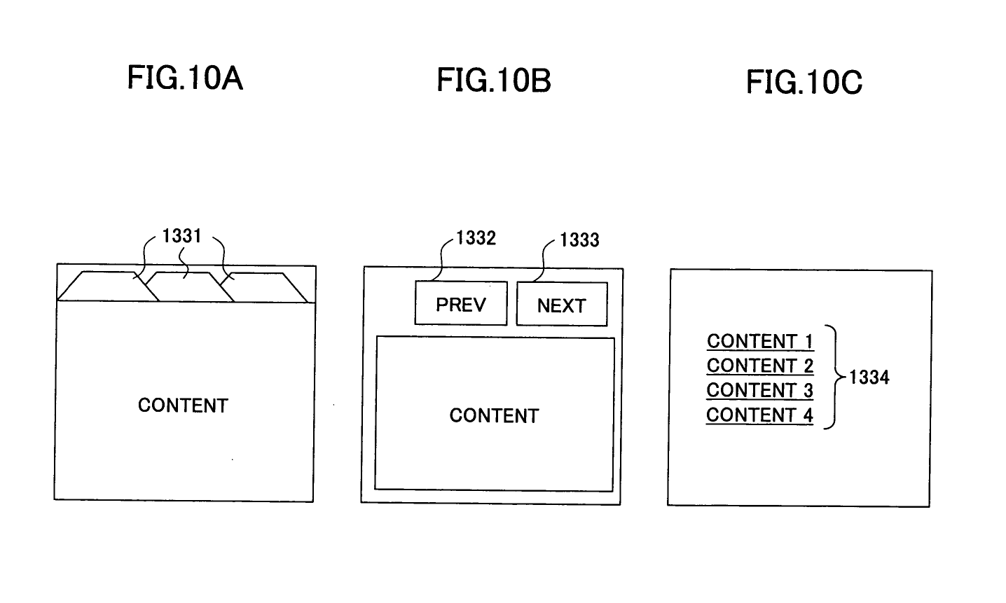

FIGS. 10A, 10B, and 10C are diagrams showing content display formats.

FIG. 10A shows a “tab format.” In the case of the tab format, the content to be displayed can be switched from one to another by operating tabs 1331.

FIG. 10B shows a “paging format.” In the case of the paging format, the page to be displayed can be switched to the previous or next page like turning a page by operating a PREV button 1332 or a NEXT button 1333.

FIG. 10C shows a “list format.” In the case of the “list format,” a list 1334 of the filenames of the content files contained in the encapsulated document 50 is displayed on the initial screen. When any of the filenames is selected from the list 1334, the content related to the selected filename is displayed or reproduced by the display program or reproduction program of the content.

On the display format selection screen, such selection of a display format is performed using radio buttons or a combo box. When any display format is selected on the display format selection screen, in step S16, the GUI unit 13 records the identifier of the selected display format (display format name) in the memory unit 103.

Next, in step S17, the GUI unit 13 causes a screen for setting (determining) security information with respect to the encapsulated document 50 to be created (hereinafter referred to as “security information setting screen”) to be displayed on the display unit 106.

Circulation of the encapsulated document 50 enables a user who otherwise cannot access the content DB 14 to view a content file through the encapsulated document 50. Accordingly, access control in the content DB 14 is meaningless unless the security of the encapsulated document 50 is ensured to some extent. Therefore, the user is caused to set information for restricting access to the encapsulated document 50.

For example, a password for executing the encapsulated document 50, a location where the encapsulated document 50 is authorized to be executed (execution authorized location), and the expiration date of the encapsulated document 50 are set (determined) on the security information setting screen. As the execution authorized location, for example, the IP address or host name and the username of a computer authorized to execute the encapsulated document 50 are set. The expiration date defines a date until which it is authorized to execute the encapsulated document 50. Accordingly, setting the expiration date makes it possible to prevent the encapsulated document 50 from being executed after passage of a certain period of time since creation of the encapsulated document 50. As the expiration date, for example, a date and time to make the expiration date are input. Alternatively, a period may be input as the expiration date.

When the security information is set on the security information setting screen, in step S18, the GUI unit 13 records the contents of the setting in the memory unit 103.

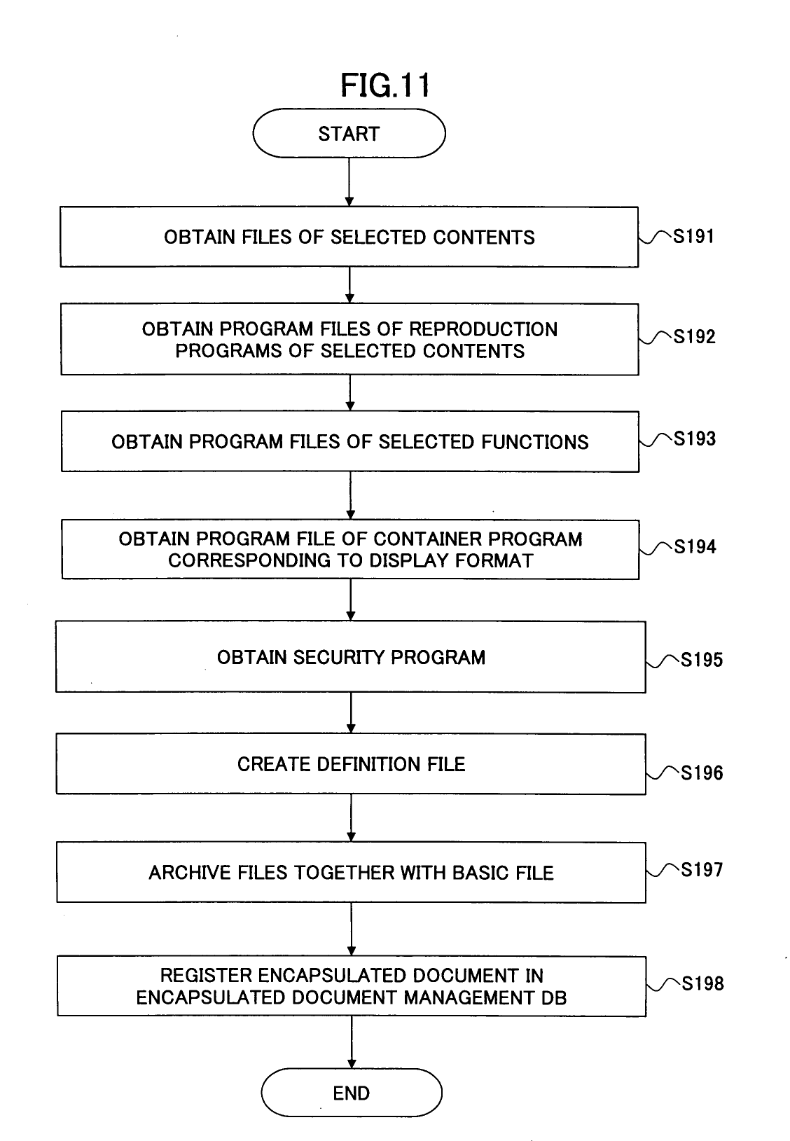

Next, in step S19, the creation unit 11 obtains information recorded in the memory unit 103 by the GUI unit 13, and creates the encapsulated document 50 based on the obtained information. A more detailed description is given of this step using FIG. 11.

FIG. 11 is a flowchart for illustrating creation of the encapsulated document 50 by the creation unit 11.

First, in step S191, the content files selected on the content selection screen 131 are obtained based on the content filenames recorded in the memory unit 103.

Next, in step S192, the program file of the display or reproduction program (hereinafter generalized as “reproduction program”) of each content file is obtained based on the content table 141 and the program table 151. That is, the function name of the reproduction program of the content file is specified by “Corresponding Function Name” of the content table 141. Further, the program table 151 is searched for a record having a function name matching the specified function name. “Filename” of the searched-out record corresponds to the filename of the reproduction program of the content file. This processing is performed for each content file.

With respect to a content file whose value of “Corresponding Function Name” is blank, a corresponding reproduction program may be determined based on the file format of the content file. The file format may be determined based on the extension of the filename of the content file.

Next, in step S193, the program files of the function programs selected on the function program selection screen 132 are obtained based on the function names recorded in the memory unit 103. That is, a filename is obtained from the program table 151 for each function name, and a program file related to the filename is obtained.

Next, in step S194, the program file of a function program that implements the function of displaying content files in a display format selected on the display format selection screen (hereinafter referred to as “display format provision function”) is obtained based on the display format name recorded in the memory unit 103. That is, the program table 151 is searched for a record whose function name matches the display format name recorded in the memory unit 103, and a file related to “Filename” of the searched-out record corresponds to the program file of the function program corresponding to the display format.

Next, in step S195, the program file of a function program for ensuring the security of the encapsulated document 50 is obtained based on the security information (execution password, execution authorized location, expiration date, etc.) recorded in the memory unit 103. For example, the program table 151 is searched for a record having “Security Function” as a function name. A file related to “Filename” of the searched-out record corresponds to the program file.

Next, in step S196, the definition file 51 to be stored in the encapsulated document 50 is created based on the information items (content filenames, function names, display format name, security information, etc.) recorded in the memory unit 103.

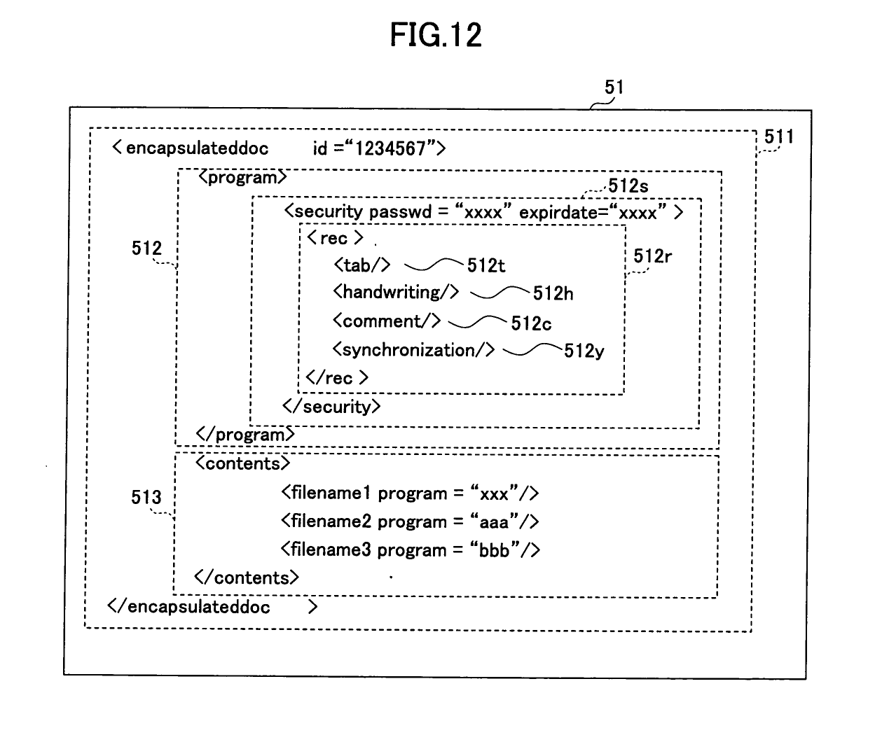

FIG. 12 is a diagram showing a description of the definition file 51. FIG. 12 shows the case where the definition file 51 is written in XML (eXtensible Markup Language). However, the description format of the definition file 51 is not limited to XML.

In the definition file 51 of FIG. 12, an “encapsulateddoc” element 511 is a root element. In the “encapsulateddoc” element 511, an “id” attribute is defined. An ID for uniquely identifying the encapsulated document 50 is written as the value of the “id” attribute.

A “program” element 512 and a “contents” element 513 are defined as the child elements of the “encapsulateddoc” element 511.

A list of function programs to be stored in the encapsulated document 50 is written in the “program” element 512. Each element corresponds to one function program in the “program” element 512. For example, a “security” element 512s indicates a function program that implements a security function. If an execution password and an expiration date are set for the encapsulated document 50, their values are, for example, encrypted, and written as a “passwd” attribute and an “expirdate” attribute, respectively, defined in the “security” element 512s. Further, a “rec” element 512r indicates a function program that implements the function of recording various operations (manipulations) (such as opening [executing], updating, and closing [ending]) with respect to the encapsulated document 50 in the encapsulated document 50 (manipulation recording function). A “tab” element 512t indicates a function program that implements displaying in the tab format in the display format provision function. A “handwriting” element 512h indicates a function program that implements the revision function. A “comment” element 512c indicates a function program that implements the comment attachment function. A “synchronization” element 512y indicates a function program for implementing a synchronous communication function (described in detail below). A parent-child relationship is defined between elements in the “program” element 512. A description is given below of the meaning of this parent-child relationship. The function identifier in the program table 151 (FIG. 4) is used for the element name of each child element of the “program” element 512.

On the other hand, a list of content files to be stored in the encapsulated document 50 is shown in the “contents” element 513. That is, elements having the filenames of the content files as their element names are written in the “contents” element 513 as its child elements. (Such elements are hereinafter referred to as “filename elements.”) A “program” attribute is defined for each filename element, and the reproduction program of the corresponding content file (a function program related to its corresponding function name) is written as the value of the “program” attribute.

After creating the definition file 51 as shown in FIG. 12, in step S197, the encapsulated document 50 is created by putting the definition file 51, the obtained content files and program files of the function programs, and a basic program together into an archive file. At this point, the content files are stored in the content folder 52 (FIG. 1), and the program files are stored in the program folder 53. If the function programs include those determined to be stored in each encapsulated document 50 as default functions, it may be required to store those function programs in the encapsulated document 50 whether or not they are selected by a user.

Next, in step S198, information on the created encapsulated document 50 is recorded in the encapsulated document management DB 16.

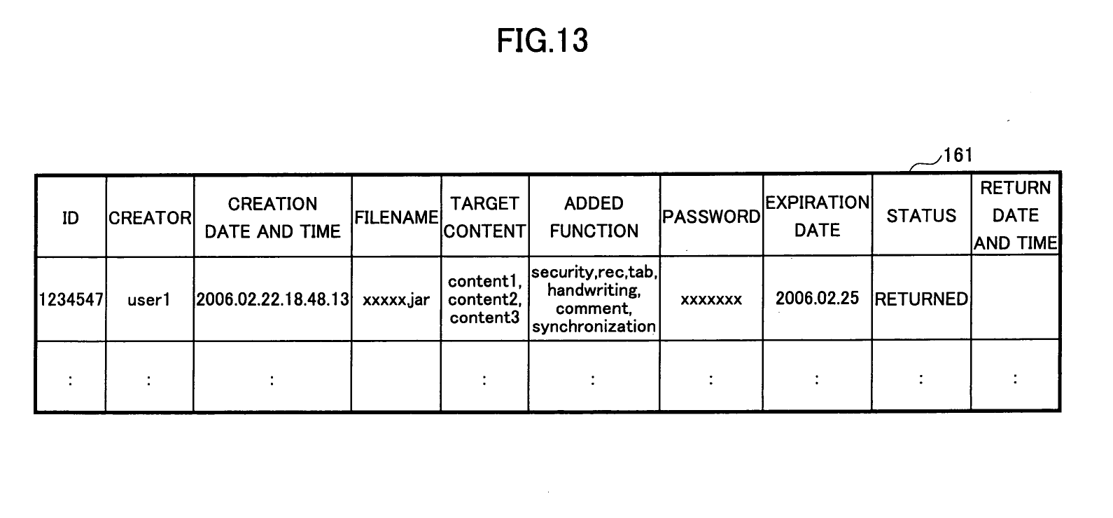

FIG. 13 is a diagram showing a configuration of an encapsulated document management table forming the encapsulated document management DB 16.

Referring to FIG. 13, an encapsulated document management table 161 includes items such as ID, Creator, Creation Date and Time, Filename, Target Content, Added Function, Password Setting, Expiration Date, Status, and Return Date and Time. The ID of the encapsulated document 50 is recorded in ID. The username of a creator of the encapsulated document 50 is recorded in Creator. The username may be specified based on, for example, an authentication function in the encapsulated document management apparatus 10. The date and time of creation of the encapsulated document 50 are recorded in Creation Date and Time. The filename of the encapsulated document 50 is recorded in Filename. The filenames of the content files stored in the encapsulated document 50 are recorded in Target Content. The function identifiers of the function programs stored in the encapsulated document 50 are recorded in Added Function.

If a password is set for the encapsulated document 50, the password is, for example, encrypted and recorded in Password Setting. If an expiration date is set for the encapsulated document 50, the date is recorded in Expiration Date. Information for determining whether the encapsulated document 50 is being used by anyone is recorded in Status. If the value of Status is “returned,” this shows that the encapsulated document 50 is not extracted from the encapsulated document management DB 16. If the value of Status is “unreturned,” this shows that the encapsulated document 50 has been extracted and is being used. The value of Status of the encapsulated document 50 immediately after its creation (registration) is “returned.” If the encapsulated document 50 is extracted (checked out) and is registered (checked in) again, the date and time of the check-in are recorded in Return Date and Time.

Thereby, the creation of the encapsulated document 50 ends. The above description is given of the case where the encapsulated document 50 is directly manipulated (operated on) by a user. However, a user's input (such as an instruction to create the encapsulated document 50) may be made on, for example, a client PC (Personal Computer) connected to the encapsulated document management apparatus 10 via a network. In this case, the GUI unit 13 displays screens such as the content selection screen on the client PC via the network. In the case of attaching importance to versatility, the GUI unit 13 may provide screens such as the content selection screen in the form of HTML data, which can be viewed with a general-purpose Web browser.

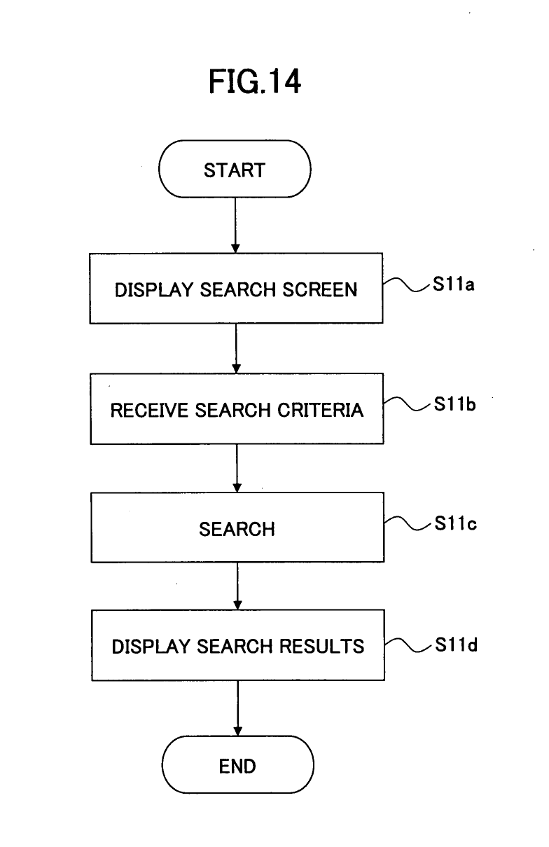

Referring back to step S11 of FIG. 7, a content file may be selected in a way other than through the content selection screen 131 shown in FIG. 8. For example, one or more search criteria (conditions) may be input to the content DB 14, and target content or a content file to be stored in the encapsulated document 50 may be selected from content files obtained as a result of the search. In this case, step S11 of FIG. 7 may be replaced with processing as shown in FIG. 14.

FIG. 14 is a flowchart for illustrating selection of target content based on search results.

First, in step S11a, the creation part 11 causes a screen for inputting search criteria to the content DB 14 (hereinafter referred to as “search screen”) to be displayed on the display unit 106.

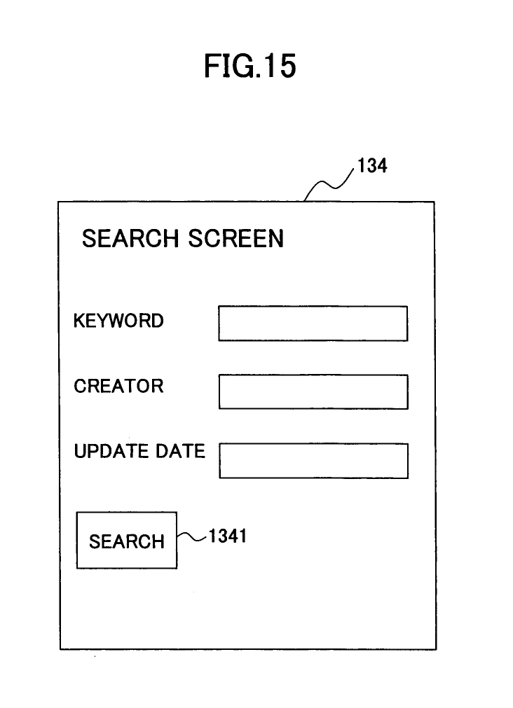

FIG. 15 is a diagram showing an example display of the search screen.

Referring to FIG. 15, a search screen 134 is configured to enable a keyword, a creator, and an update date to be input thereon. The items forming search criteria are not limited to these, and may be suitably determined in accordance with the configuration of the content DB 14.

When search criteria are input and a SEARCH button is operated on (for example, clicked) by a user in step S11b, in step S11c, the creation part 11 searches the content DB 14 for one or more content files that match the search criteria. Then, in step S11d, the creation part 11 causes a screen for selecting target content (a content file) from search results (hereinafter referred to as “search result display screen”) to be displayed on the display unit 106.

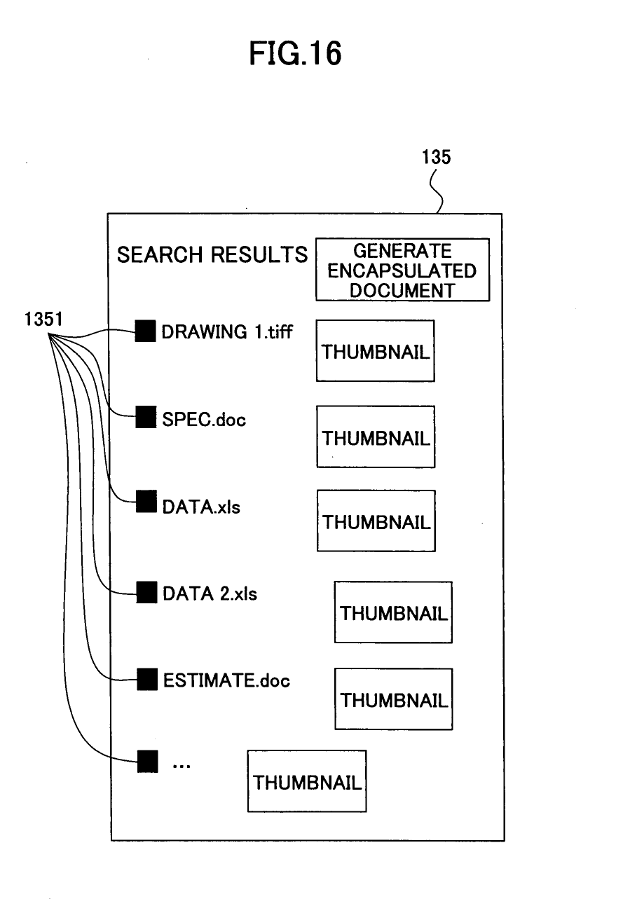

FIG. 16 is a diagram showing an example display of the search result display screen.

Referring to FIG. 16, searched-out (retrieved) content files are displayed in a list on a search result display screen 135. A filename and a thumbnail are displayed for each content file. Further, a check button 1351 is provided for each content file on the search result display screen 135. The user can select (determine) a content file to be included in the encapsulated document 50 by selecting the corresponding check button 1351.

Further, for example, in the case where the GUI unit 13 of the encapsulated document management apparatus 10 is displaying a screen that displays multiple content files as targets of display (hereinafter referred to as “content file display screen”), an instruction to create the encapsulated document 50 may be received from this screen.

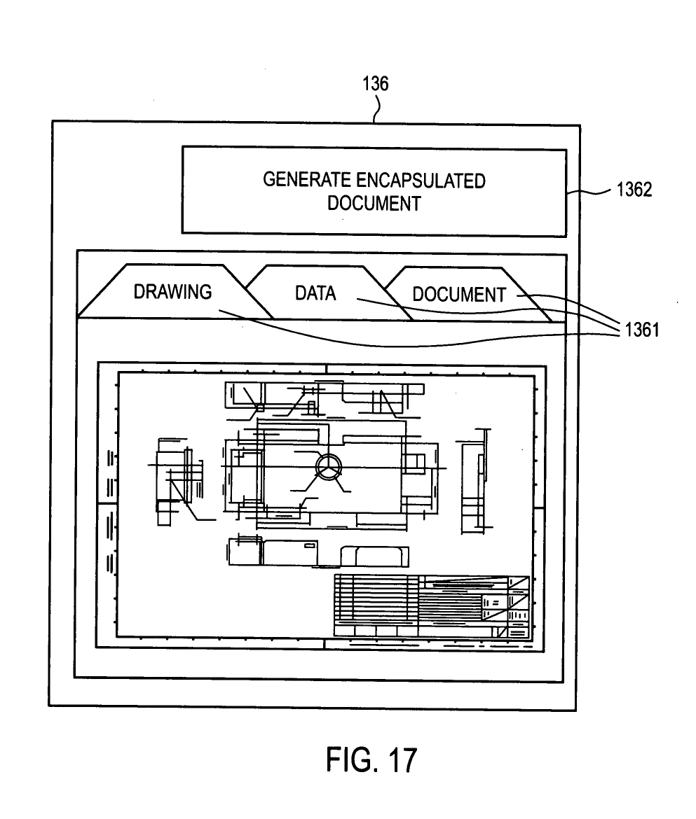

FIG. 17 is a diagram showing an example display of the content file display screen by the GUI part 13.

On a content file display screen of FIG. 17, multiple content files are shown as targets of display, and the content file to be visualized can be switched from one to another using tabs 1361. If an encapsulated document creation button 1362 is operated on (for example, clicked) on the content file display screen 136, the creation unit 11 determines that the content files shown as targets of display are target content files.

By the way, as a practical matter, if a content file is dependent on a specific application, it is difficult to include the application as a reproduction program in the encapsulated document 50 because of problems such as the necessity of a license and installation. Further, there are various formats for audio data and video data. Accordingly, the content file may be in a format that is not supported at a distribution destination of the encapsulated document 50.

Therefore, in archiving content files in step S197 of FIG. 11, the creation unit 11 may convert the original content file into another format, and include not only the original file but also its format-converted version (the format-converted file) in the encapsulated document 50. For example, if the original file is an Office application file, the original file may be converted into another format such as SVG (Scalable Vector Graphics) by interpreting a GDI (Graphics Device Interface) command of an OS (Operating System) through a printer driver. Such a conversion technique is described in detail in Japanese Laid-Open Patent Application No. 2005-63243. Further, audio data or video data may be converted into such formats as to enable the audio or video data to be reproduced with a reproduction program managed (in the program DB 15) in the encapsulated document management apparatus 10.

By packaging the format-converted version of a content file and a reproduction program corresponding to the converted format together in the encapsulated document 50, the corresponding content contained in the encapsulated document 50 becomes viewable independent of the environment. However, a file converted into a standard format may be difficult to handle in practice. Accordingly, even in the case of packaging a file converted into a standard format, it is preferable to also include the original file in the encapsulated document 50, for this makes it possible to have the original file viewed in an environment where it is possible to view the original file and to have the converted file (SVG) viewed in an environment where it is not.

The file into which the original file is converted is stored in the content folder 52, and its reproduction program is stored in the program folder 53.

[Distribution of Encapsulated Document]

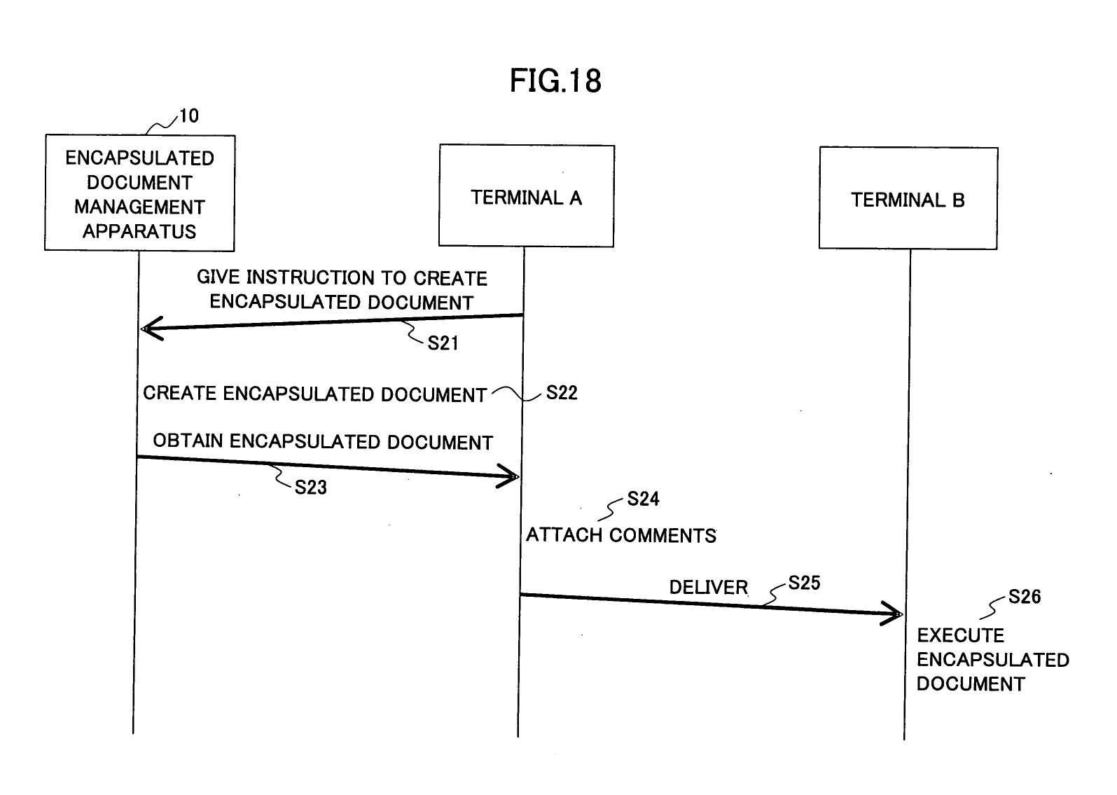

FIG. 18 is a sequence diagram for illustrating distribution (or circulation/delivery) of the encapsulated document 50. In FIG. 18, Terminal A indicates a client PC used by User A, and Terminal B indicates a client PC used by User B.

Steps S21 and S22 represent the above-described creation of the encapsulated document 50. That is, when an instruction to create the encapsulated document 50 is input from the terminal A in step S21, in step S22, the encapsulated document management apparatus 10 creates the encapsulated document 50.

In the case where User A delivers the encapsulated document 50 to another user (for example, the user B), User A inputs an instruction to extract the encapsulated document 50 through the GUI unit 13 of the encapsulated document management apparatus 10. Terminal A notifies the management unit 12 of the encapsulated document management apparatus 10 of the instruction of User A. In step S23, the management unit 12 extracts the encapsulated document 50 from the encapsulated document management DB 16, and returns the extracted encapsulated document 50 to Terminal A (check-out). The management unit 12 sets “unreturned” in “Status” of the checked-out encapsulated document 50 in response to the check-out. Further, the management part 12 may lock content files related to the target contents of the checked-out encapsulated document 50.

Next, in step S24, User A executes the encapsulated document 50 in Terminal A, and performs an operation (manipulation) on content contained in the encapsulated document 50, such as attaching comments thereto. As a result, the intention of User A (or what User A means) regarding the content is added to the encapsulated document 50. The operation such as attachment of comments is realized by a corresponding function program contained in the encapsulated document 50, and the attached comments are recorded in the encapsulated document 50, of which a detailed description is given below. Then, in step S25, User A attaches the encapsulated document 50 to an e-mail message, and transmits the e-mail message to User B. In step S26, User B receives the encapsulated document 50, and executes the encapsulated document 50 in Terminal B, thereby viewing the content file contained in the encapsulated document 50.

At this point, the comments representing the intention of User A are attached to the content file. Accordingly, it is very likely that User B will pay attention to a part to which the comments of the user A are attached. Therefore, the intention of the user A is more likely to be communicated to User B.

[Execution (Activation) of Encapsulated Document]

A description is given of an operation in the case of User B, having received the encapsulated document 50, executing the encapsulated document 50.

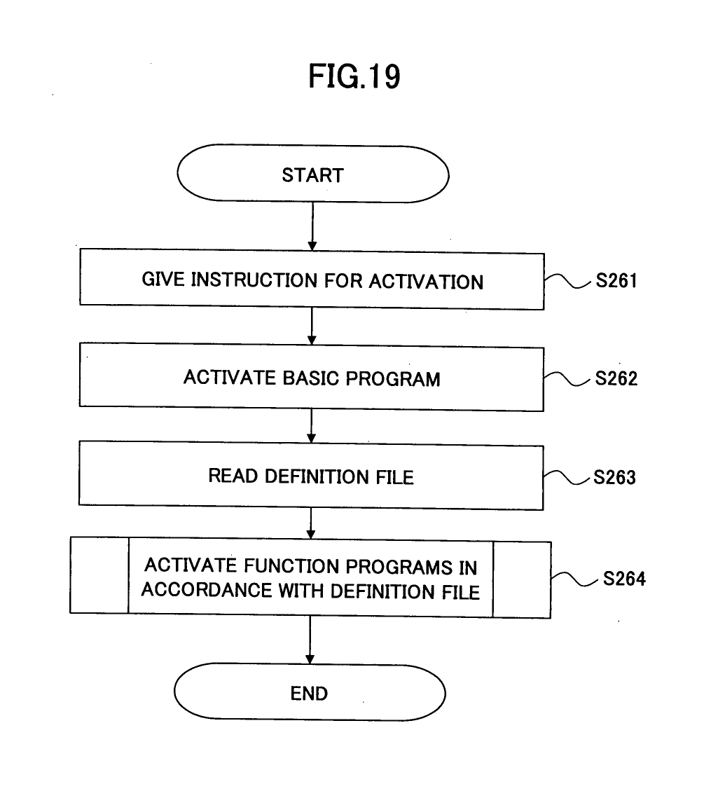

FIG. 19 is a flowchart for illustrating execution of the encapsulated document 50. This operation is performed while the encapsulated document 50 is retained in a file system implemented in a general-purpose computer such as a PC having a hardware configuration as shown in FIG. 5 (Terminal B in the case of FIG. 18).

In step S261, an instruction to execute the encapsulated document 50 is given by, for example, double-clicking the icon of the encapsulated document 50. Then, in step S262, a basic program contained in the program folder 53 of the encapsulated document 50 is executed as a main program based on the definition of a manifest file. In step S263, the basic program reads the definition file 51 in the encapsulated document 50 into memory. Then, in step S264, the basic program activates the function programs contained in the program folder 53 in accordance with the definition of the definition file 51.

A description is given in more detail of step S264.

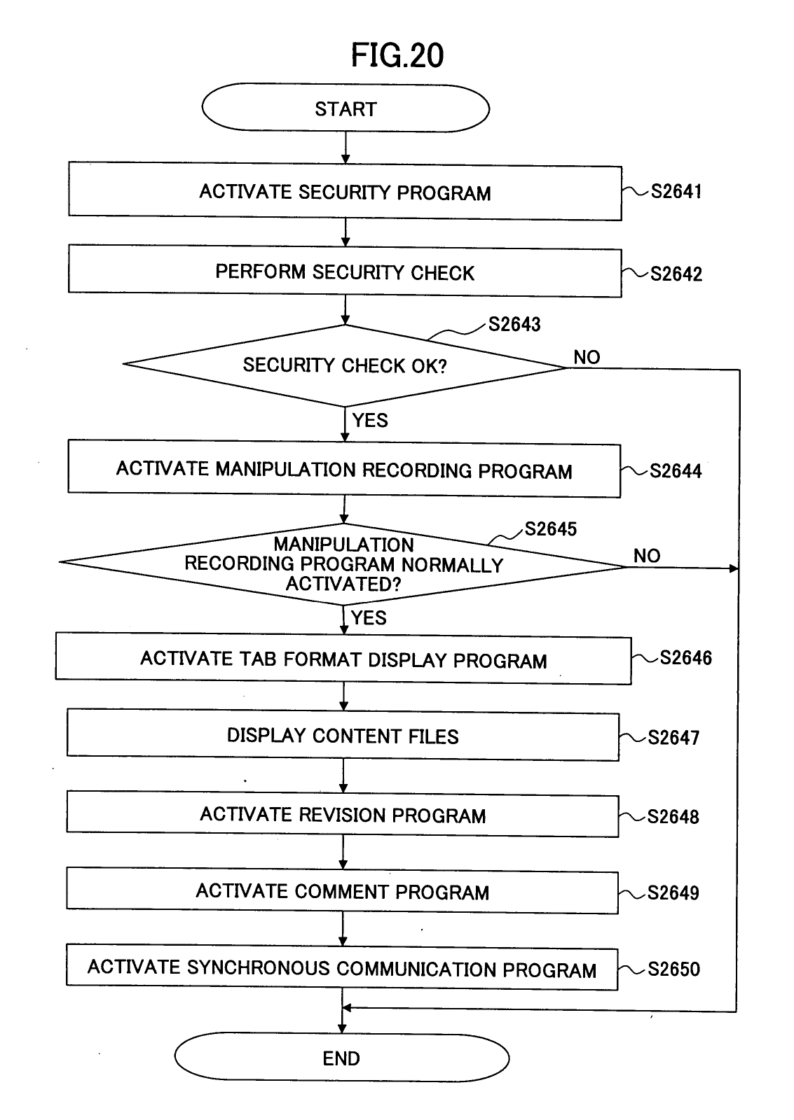

FIG. 20 is a flowchart for illustrating activation of function programs. The specific contents of activation of function programs differ depending on the contents of the definition of the definition file 51. In FIG. 20, a description is given of the case where the contents of the definition of the definition file 51 are as shown in FIG. 12.

First, in step S2641, the basic program activates a function program related to one of the child elements of the “program” element 512 (FIG. 12) of the definition file 51 which one is defined at the top. In FIG. 12, the “security” element 512s is defined at the top. Accordingly, a security program implementing a security function is activated.

In step S2642, the activated security program performs a security check on the encapsulated document 50 based on the security information (execution password, expiration date, execution authorized location, etc.) set in the attributes of the “security” element 512s.

For example, if an execution password is set, the security program causes a dialog for inputting an execution password to be displayed on a display unit, and collates a character string input by User B with the set execution password. Further, if an expiration date is set, the security program compares a current date and time with the set expiration date. Further, if an execution authorized location is set, the security program collates, for example, the JP address of the apparatus serving as an execution location with the set IP address. In this case, the security information is written in the definition file 51. However, the security information does not necessarily have to be written in the definition file 51. For example, the password and the expiration date are managed in the encapsulated document management table 161 of FIG. 13. Accordingly, the security program may obtain the password and the expiration date recorded in the encapsulated document management table 161 by communicating with the management part of the encapsulated document management apparatus 10, and performs a security check using the obtained information. The execution authorized location is omitted in the definition file 51 and the encapsulated document management table 161 for convenience of description.

If the result of the security check is affirmative (for example, the expiration date has not passed and a correct password has been entered) (YES in step S2643), in step S2644, the basic program activates a function program corresponding to the element defined in the next layer (“rec” element 512r) in the definition file 51 (a manipulation recording program). The manipulation recording program is activated to start recording the contents of operations (manipulations) on the encapsulated document 50.

If the manipulation recording program has been normally activated (YES in step S2645), in step S2646, the basic program activates a tab format display program that implements a display in the tab format based on the “tab” element 512t, which is one of the child elements of the “rec” element 512r written at the top. In step S2647, the activated tab format display program recognizes the content files contained in the content folder 52 based on the “contents” element 513 of the definition file 51, and causes a display screen of the tab format having the content files as display targets to be displayed. The tab format display program determines a reproduction program to interpret and display each content referring to the value of the “program” element of the “filename” element corresponding to each content file, and activates the reproduction program on the display screen of the tab format, thereby causing each content to be displayed.

Next, the basic program activates function programs related to the other child elements of the “rec” element 512r in order. That is, in step S2648, the basic program activates a revision program that implements the revision function based on the “handwriting” element 512h. Then, in step S2649, the basic program activates a comment program that implements the comment attachment function. Then, in step S2650, the basic program activates a synchronous communication program that implements the synchronous communication function. At this point, the GUI components of the revision program, the comment program, and the synchronous communication program for causing the corresponding functions to be used are displayed on the display screen displayed by the tab format display program (hereinafter referred to as “encapsulated document display screen”). Accordingly, for example, a REVISION button for the revision program, a COMMENT button for the comment program, and a SYNCHRONOUS COMMUNICATION button for the synchronous communication program are displayed on the encapsulated document display screen.

On the other hand, if the result of the security check is negative (NO in step S2643), or if the manipulation recording program has not been normally activated (NO in step S2645), the basic program ends execution of the encapsulated document 50. That is, the hierarchical relationship among the child elements of the “program” element 512 of the definition file 51 represents dependency in activation of each function program. To put it in more detail, it shows that a lower program is activated if the processing result of an upper program is normal.

[Communications Using Encapsulated Document]

Next, a description is given of the communications between User A and User B using the encapsulated document 50. The communications using the encapsulated document 50 are roughly divided into asynchronous communications and synchronous communications.

[Asynchronous Communications]

Asynchronous communications refer not to real-time communications but to, for example, such communications where there is a time lag in the response of User B to an inquiry by User A. Typical examples of asynchronous communications include communications via e-mail. Accordingly, the delivery of the encapsulated document 50 using e-mail described with reference to FIG. 18 typifies asynchronous communications.

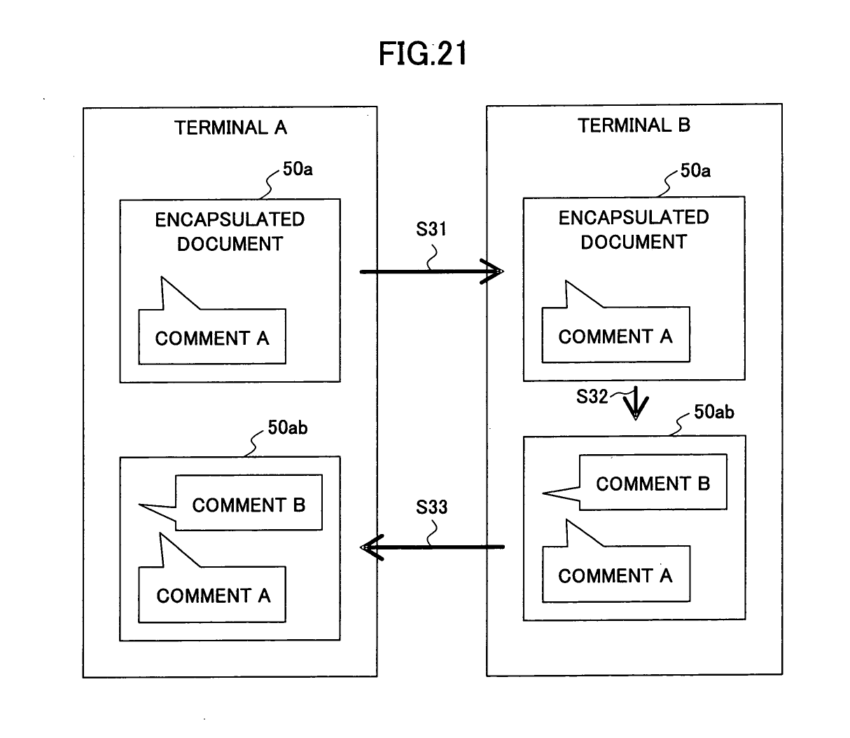

FIG. 21 is a diagram conceptually showing example asynchronous communications.

Referring to FIG. 21, in step S31, an encapsulated document 50a having Comment A attached thereto by User A in Terminal A is delivered to Terminal B. In step S32, User B, who has received the encapsulated document 50a, refers to Comment A attached by User A and adds Comment B as a response to Comment A in Terminal B. In step S33, an encapsulated document 50ab having Comment B added thereto is returned to Terminal A.

Thus, in the case of FIG. 21, there are asynchronous communications between User A and User B as a result of attachment of comments to the encapsulated document 50.

In the case of attaching a comment to any of the content files contained in the encapsulated document 50, a user operates (for example, clicks) the COMMENT button. Detecting the clicking of the COMMENT button, the comment program causes a dialog box for entering a comment to be displayed. When the user enters a comment in the dialog box and further clicks a position on the content file to which position the comment is to be attached, the comment program causes the comment to be displayed at the clicked position, and records data on the comment in the encapsulated document 50. The data on the comment are recorded as a file (hereinafter referred to as “comment file”) in a folder other than the content folder 52 and the program folder 53, such as a record folder.

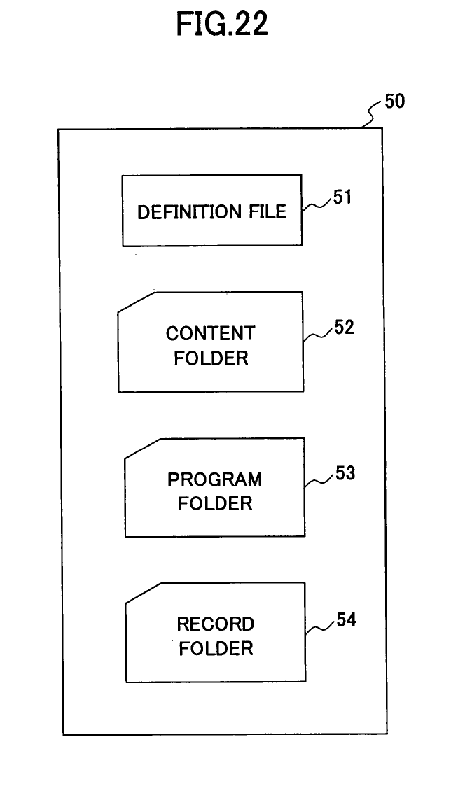

FIG. 22 is a diagram showing a structure of the encapsulated document 50 with a record folder.

It is assumed that a comment is attached to any of the content files of the encapsulated document 50. In this case, if there is no record folder in the encapsulated document 50, the comment program creates a record folder 54, and creates a comment file in the newly created record folder 54. On the other hand, if the record folder 54 has already been created, the comment program creates a comment file in the existing record folder 54.

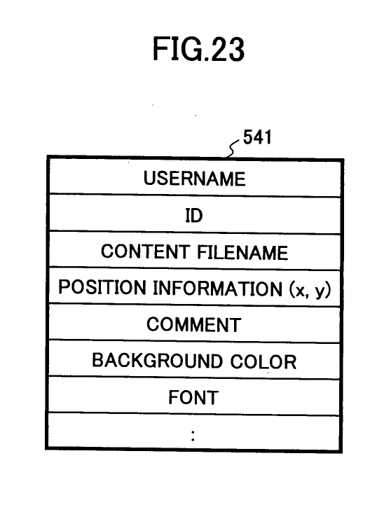

FIG. 23 is a diagram showing a configuration of the comment file.

Referring to FIG. 23, a username, an ID, a content filename, position information, a comment, a background color, and a font are recorded for each comment in a comment file 541. The username is that of a user who has attached the comment. The ID is that of the encapsulated document 50 to which the comment is attached. The content filename is the filename of a content file to which the comment is attached. The position information is information for identifying a position where the comment is attached in the content file (such as coordinate information). The comment is the text of the attached comment. The background color and the font are those of the comment at the time of its display.

Every time a comment is attached to any of the content files of the encapsulated document 50, the comment file 541 is accumulated in the record folder 54.

[Synchronous Communications]

Unlike in asynchronous communications, an operation (manipulation) performed on the encapsulated document 50 by one user is reflected in real time in the encapsulated document 50 of a partner user in synchronous communications. For example, if Content 1 is displayed in the encapsulated document 50 of Terminal A, Content 1 is also displayed in the encapsulated document 50 of Terminal B. Such a synchronous display of content typifies synchronous communications.

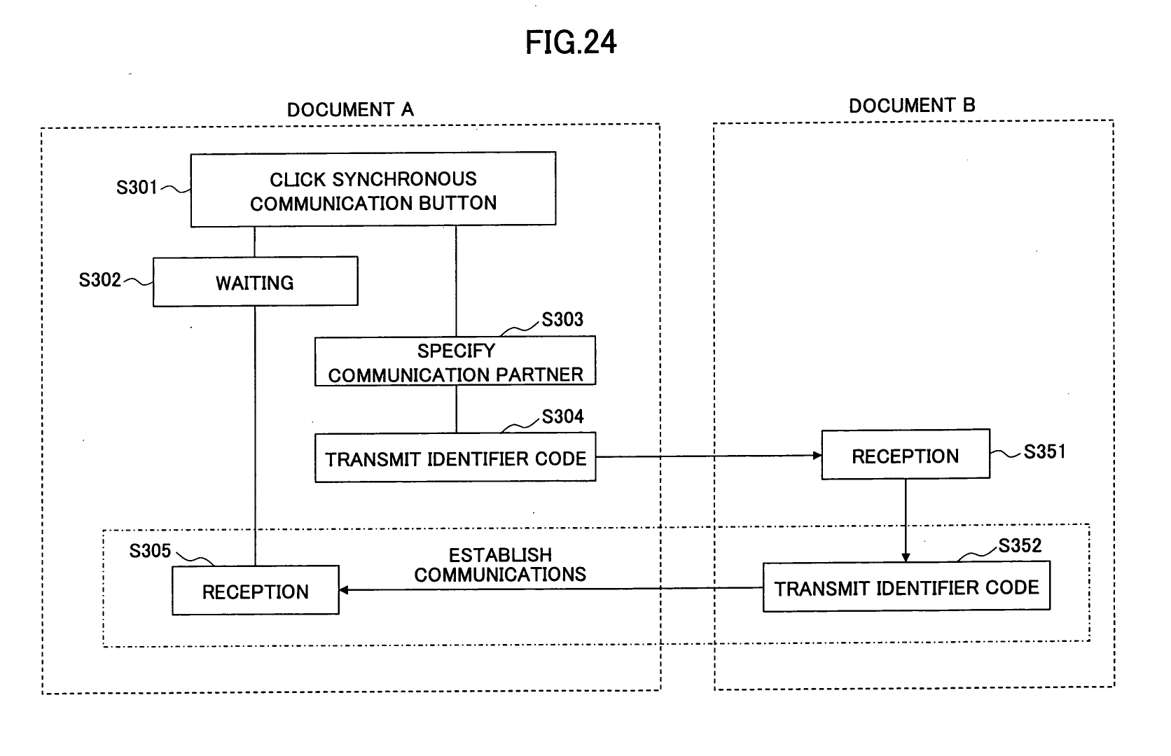

FIG. 24 is a flowchart showing a flow of establishing communications between encapsulated documents. Here, a description is given of the case where synchronous communications are established between Document A, which is the encapsulated document 50 executed in Terminal A, and Document B, which is the encapsulated document 50 executed in Terminal B. Document A has been delivered from Terminal A to Terminal B to serve as Document B in Terminal B. Accordingly, Document A and Document B have the same contents.

When a function program that implements synchronous communications (synchronous communication program) in Document A that has been activated in Terminal A detects clicking of the SYNCHRONOUS COMMUNICATION button in step S301, in step S302, the synchronous communication program opens a socket and waits for communications. The port used at this point may be common to the documents.

Next, in the case of specifying Document B that has been executed in Terminal B, which is a communication partner (step S303), in step S304, the synchronous communication program transmits the document identifier code of Document A to Terminal B. This processing in step S304 may be performed in another thread.

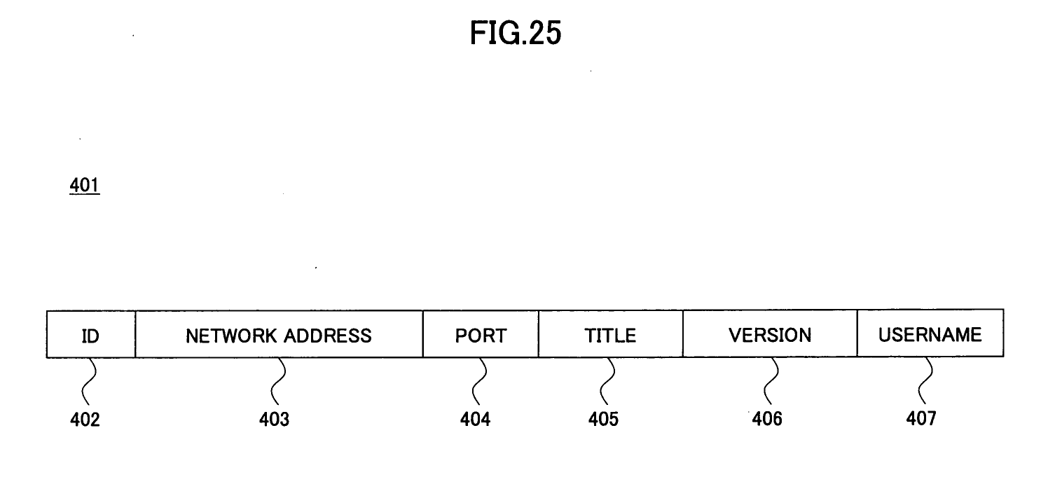

FIG. 25 is a schematic diagram showing an example of the document identifier code, which is for identifying a document.

Referring to FIG. 25, a document identifier code 401 contains information such as an ID number 402, a network address number (JP address) 403, a port number 404, a title 405, a version 406, and a username 407.

In this case, Document B, which is a communication partner, may be specified by the network address number (IP address) 403 of Document B or by the username 407 of Document B.

Next, if Document B, which is a transmission destination, is ready for reception, in step S351, the synchronous communication program of Document B receives a request to establish communications from the synchronous communication program of Document A. In step S352, the synchronous communication program of Document B, which has received the request to establish communications from Document A, registers Document A as a communication partner, and transmits the document identifier code 401 of Document B to Document A. The document identifier code 401 in this case may be the network address number (JP address) 403 of Document B, the username 407 of Document B, or any other information of Document B.

Next, in step S305, the synchronous communication program of Document A receives the document identifier code 401 of Document B transmitted from the synchronous communication program of Document B. Thereby, communications are established between Document A and Document B.

Once communications are established between two documents, synchronous communications are performable between the two documents.

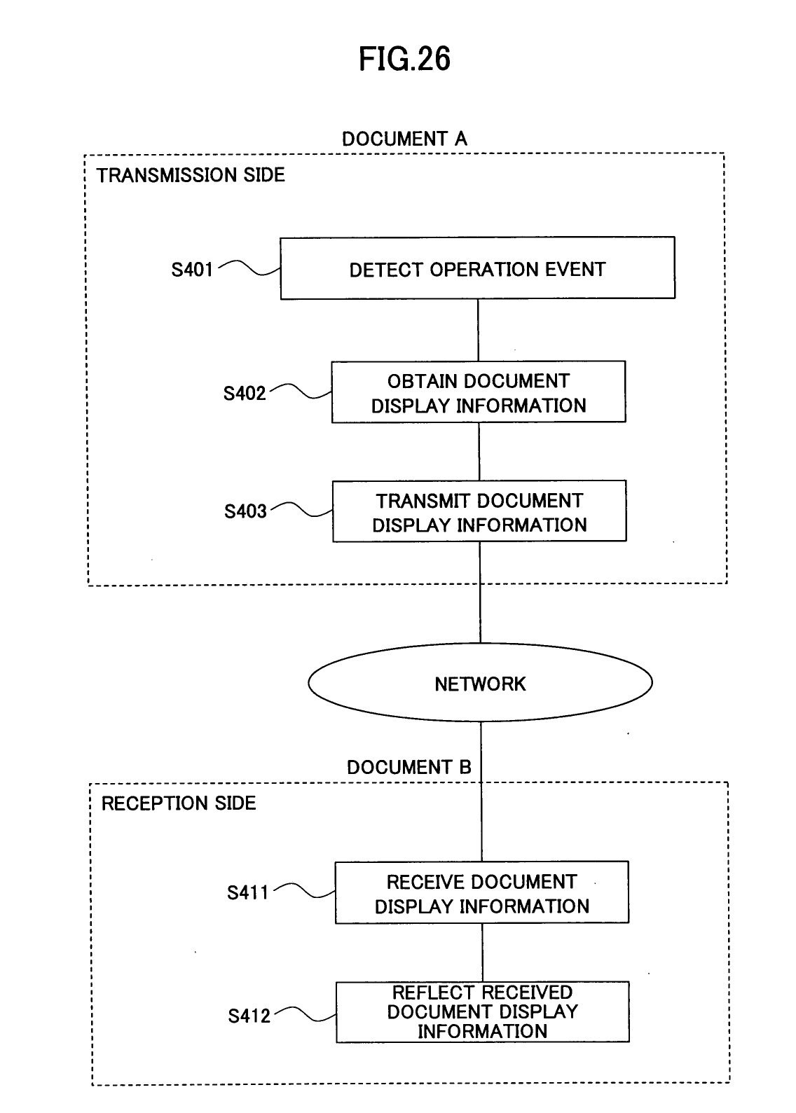

FIG. 26 is a flowchart for illustrating a synchronous communication operation.

Document A and Document B in FIG. 26 have the same meanings as in FIG. 24. For example, if an operation (manipulation) such as displaying content, turning a page, or enlarging/reducing size is performed on the encapsulated document display screen caused to display Document A, in step S401, the synchronous communication program detects an event corresponding to the operation, and in step S402, the synchronous communication program obtains the document condition information of Document A. Here, the document condition information refers to information on the state of display of Document A. For example, the document condition information means information indicating that the n^{th} page of a content file a is displayed. Then, in step S403, the synchronous communication program transmits the document condition information of Document A to Terminal B having Document B executed.

In step S411, the synchronous communication program of Document B receives the document condition information of Document A. Then, in step S412, the synchronous communication program of Document B changes the state of display of Document B in the same manner as that of Document A based on the received document condition information of Document A.

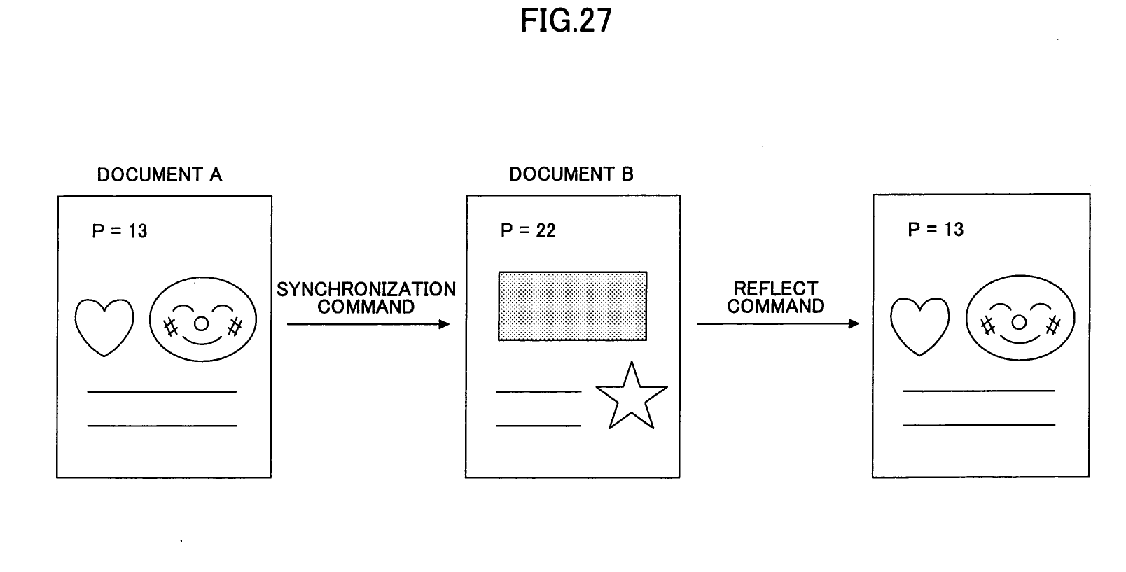

FIG. 27 is a schematic diagram showing two synchronized encapsulated documents.

It is assumed that Document A executed in Terminal A displays page 13 (P13) of the content file a and Document B executed in Terminal B displays page 22 (P22) of the content file a before synchronization. When Document A transmits its document condition information to Document B in this state, Document B receives the document condition information and reflects the received document condition information in the state of display of Document B. As a result, Document B displays page 13 of the content file a the same as Document A.

[Recordation of Manipulation Log of Encapsulated Document]

As described above, the encapsulated document 50 is created and distributed (or circulated/delivered) to become a target of various manipulations. A description is given of the function of recording such various manipulations of the encapsulated document 50 (manipulation recording function).

The manipulation recording function is implemented by the manipulation recording program, which is one of function programs. Every time an operation (manipulation) such as creating or executing the encapsulated document 50, displaying a content file, editing, replacing, adding, or deleting a content file, attaching comments, executing synchronous communications, or ending the encapsulated document 50 is performed, the manipulation recording program obtains information on the manipulation (manipulation information), and records the manipulation information in a manipulation log file in the record folder 54. The above-described manipulations are implemented by their corresponding function programs. Accordingly, the manipulation recording program obtains the manipulation information from a function program corresponding to the manipulation. In the case of editing of a content file, information such as the update date and the capacity of the file is updated when the content file is stored after its editing. Accordingly, the manipulation may be detected by changes in such file attributes.

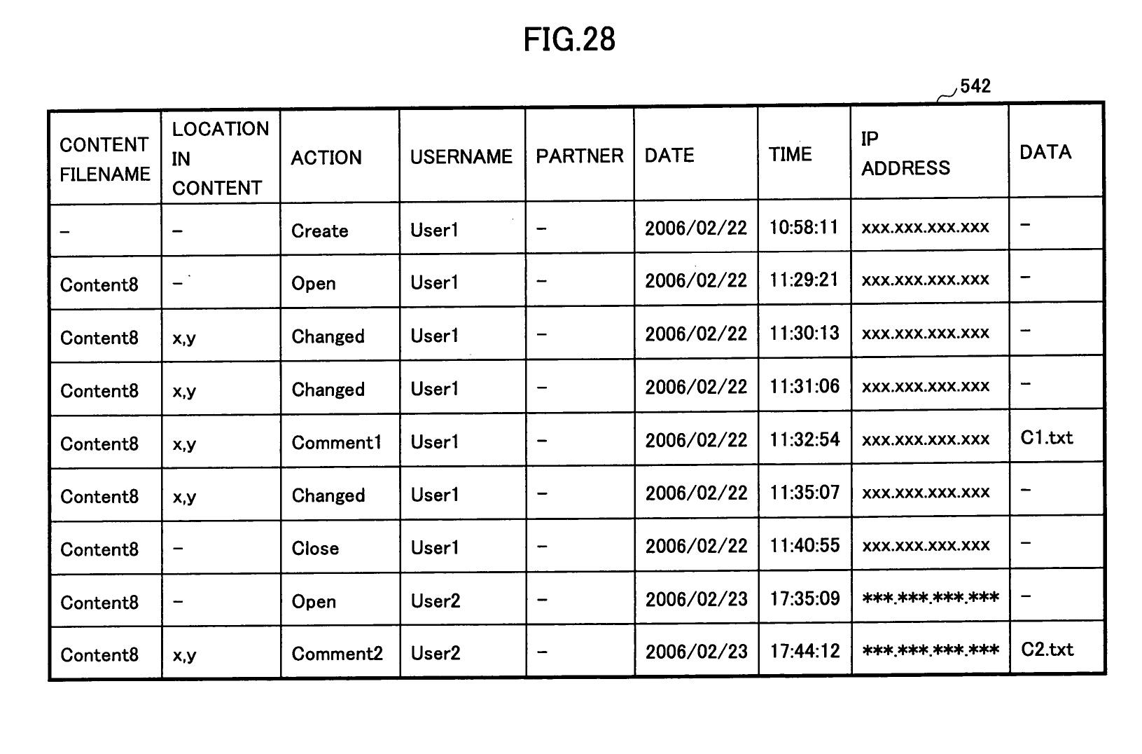

FIG. 28 is a table showing a configuration of the manipulation log file.

Referring to FIG. 28, a content filename, a location in the content, an action, a username, a partner, a date, a time, an IP address, and a log of manipulations of data (history information) are recorded for each manipulation in a manipulation log file 542.

The content filename is the filename of a content file subjected to the manipulation. The location in the content is information indicating a position subjected to the manipulation in the content file (for example, coordinate values), and is recorded in accordance with the manipulation. For example, if a comment has been attached, coordinates to which the comment has been attached are recorded. The action is a character string for identifying the manipulation. The username is the name of a user who has performed a principal role in the manipulation. The partner is the username of the partner of the manipulation if the manipulation is accompanied by a partner as in the case of synchronous communications. The date and the time are those of the performance of the manipulation. The JP address is that of a terminal at which the manipulation has been performed. The data are those on the manipulation. For example, if a comment has been attached, the filename of its comment file corresponds to the data. Thus, what type of action (manipulation) has been performed, who has performed the action, when and where the action has been performed, and on which content file the action has been performed are successively recorded in the manipulation log file 542. In the case of FIG. 28, the manipulation log file 542 shows that the encapsulated document 50 has been created by User 1, that a series of manipulations of “activation→editing→editing→attaching a comment→editing→closing” has been performed on Content 8 by User 1 in a terminal related to an JP address “xxx.xxx.xxx.xxx,” and that Content 8 has been further activated and had a comment attached thereto by User 2 in a terminal related to an JP address “***.***.***.***.”

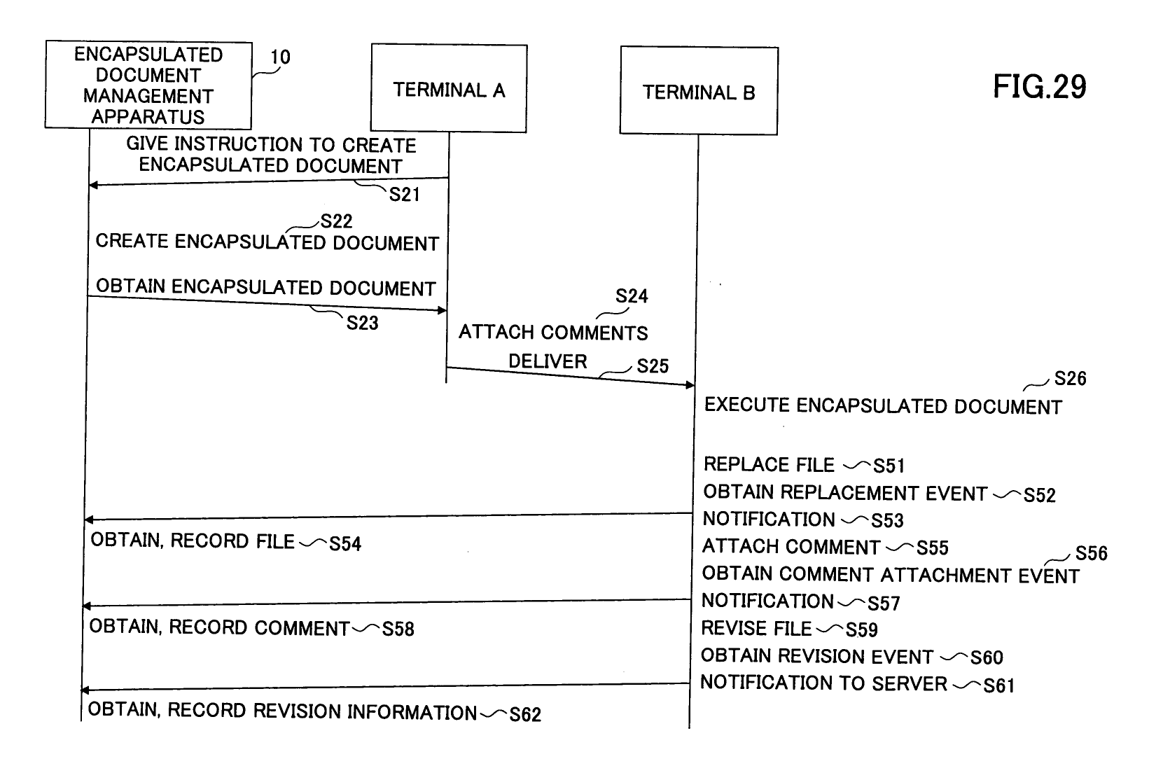

Manipulation logs may be recorded in the encapsulated document management apparatus 10 instead of the encapsulated document 50. FIG. 29 shows an operational sequence in this case.

FIG. 29 is a sequence diagram for illustrating an operation in the case of transmitting manipulation logs from the encapsulated document 50 to the encapsulated document management apparatus 10. In FIG. 29, the same steps as those of FIG. 18 are referred to by the same step numbers, and a description thereof is omitted.

Updating (replacing) a content file (step S51), attaching a comment to the content file (step S55), and revising the content file (step S59) are executed by corresponding function programs of the encapsulated document 50 executed in Terminal B in accordance with instructions from User B. Then, the manipulation recording program detects their respective manipulation events (steps S52, S56, and S60), and transmits information corresponding to the manipulations to the encapsulated document management apparatus 10. For example, when a content file is replaced (updated), the manipulation recording program transmits a manipulation log related to the manipulation and the updated content file (step S53). When a comment is attached, the manipulation recording program transmits a manipulation log related to the manipulation and the comment file 541 (step S57). When the content file is revised, the manipulation recording program transmits a manipulation log related to the manipulation and revision information (step S61).

In the encapsulated document management apparatus 10, when information such as the manipulation logs are received from the manipulation recording program, the management part 12 records the information in the content DB 14 and the communication DB 17 (S54, S58, and S62). At this point, the management part 12 may monitor the presence or absence of illegal manipulations on the encapsulated document management apparatus 10 based on the manipulation logs.

Information on the encapsulated document management apparatus 10, such as an IP address, may be recorded in the encapsulated document 50 in order to enable the manipulation recording program to establish communications with the encapsulated document management apparatus 10. For example, the location of creation of the encapsulated document 50, that is, the IP address of the encapsulated document 50, is recorded in IP ADDRESS of the first line (manipulation log at the time of creation) of the manipulation log file of FIG. 28, and this IP address may be employed. In the case of failure in communications, a manipulation log may be recorded in the encapsulated document 50 as described above.

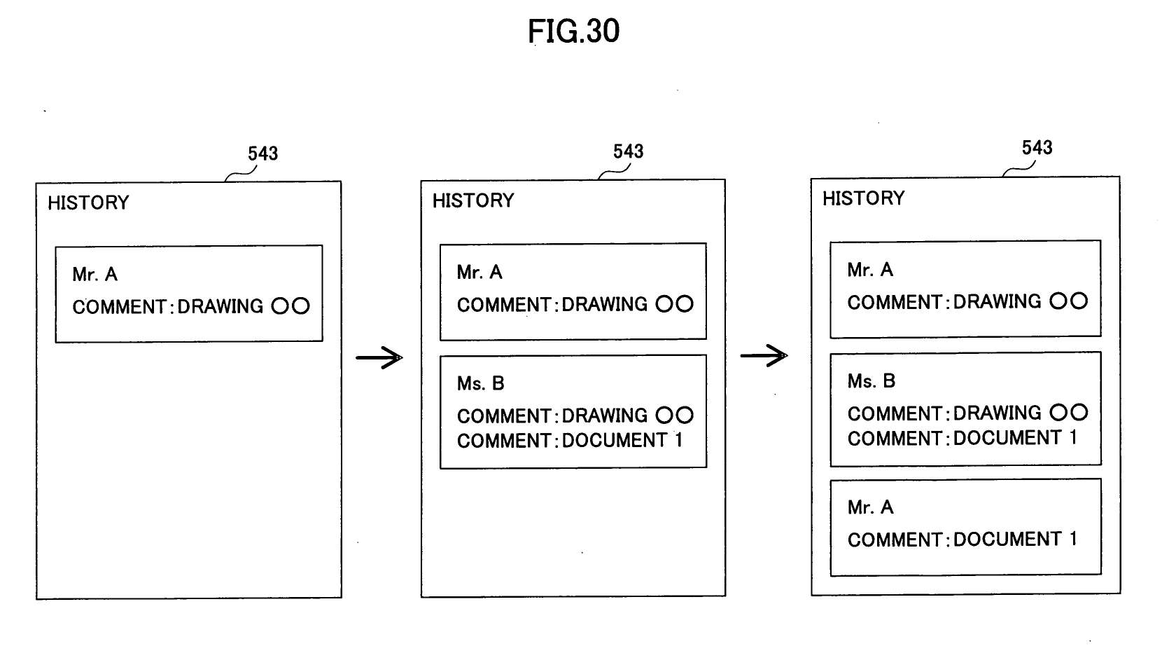

If the encapsulated document 50 contains a function program that causes a manipulation log to be displayed (a manipulation log display program), manipulation logs may be referred to while the encapsulated document 50 is being executed. In this case, the manipulation log display program causes, for example, a manipulation log screen as shown in FIG. 30 to be displayed based on the manipulation logs recorded in the manipulation log file 542.

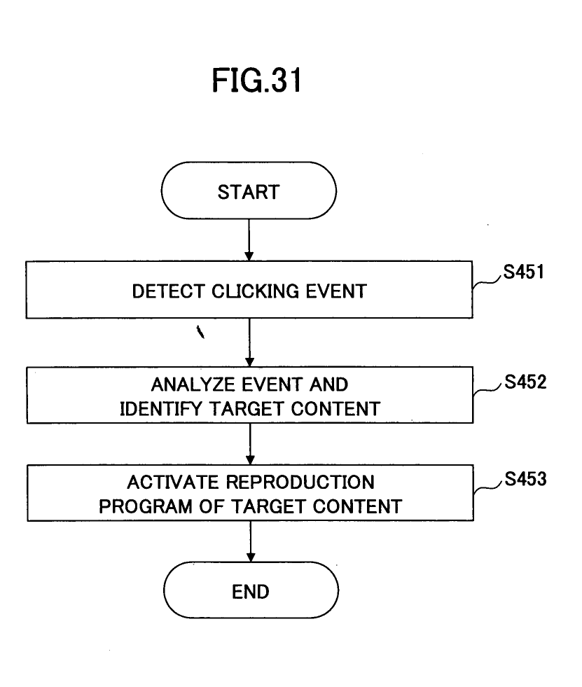

FIG. 30 is a diagram showing an example display of the manipulation log screen. FIG. 30 shows how manipulation logs are accumulated in time series and new manipulation logs are added to a manipulation log screen 543 accordingly. If any of the manipulation logs is clicked on the manipulation log screen 543, an operation as shown in FIG. 31 is performed.

FIG. 31 is a flowchart for illustrating an operation at the time when a manipulation log is clicked.

When the manipulation log display program detects clicking of any of the manipulation logs displayed on the manipulation log screen 543 (step S451), the manipulation log display program identifies the clicked manipulation log based on the position of the clicking, and further identifies a content file related to the manipulation log based on the manipulation log file 542 (step S452). Next, the manipulation log display program determines the identified content file as a target of processing, and activates the reproduction program of the content file (step S453). Thus, from a manipulation log, a user can easily check a content file regarding the manipulation log.

[Other Recording Information]

If the encapsulated document 50 contains a function program that enables audio or video to be captured, audio or video may be recorded as information regarding communications via the encapsulated document 50. In this case, an apparatus such as an audio microphone or a video recorder has to be connected to a terminal in which the encapsulated document 50 is executed. The function program starts recording audio or video in response to input of the audio or video. The collected audio data or video data are recorded in the record folder 54. Further, the start of audio recording or video recording is recorded in the manipulation log file 542 by the manipulation recording program.

[Re-Storing Encapsulated Document]

If a content file has been revised, has had a comment attached thereto, or has been edited in the encapsulated document 50 through communications between users, the encapsulated document 50 is re-stored in (written back to) the encapsulated document management apparatus 10.

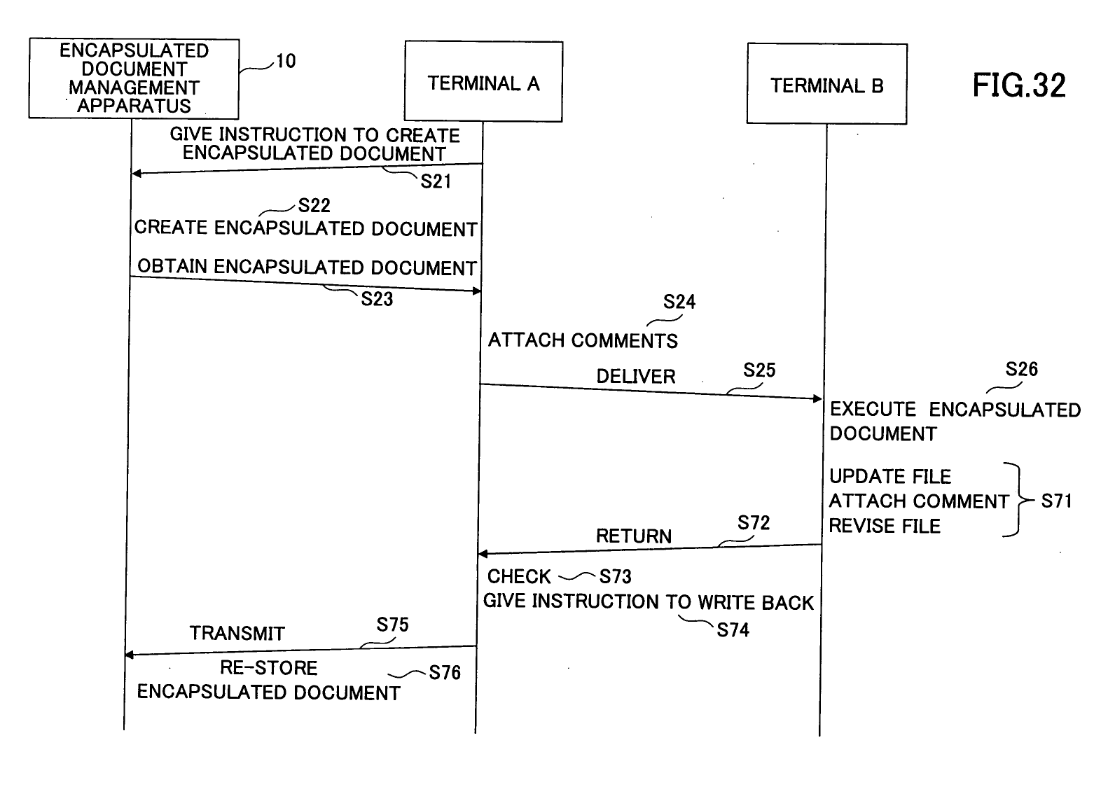

FIG. 32 is a sequence diagram showing the operation from creation up to re-storing of the encapsulated document 50. In FIG. 32, the same steps as those of FIG. 18 are referred to by the same step numbers, and a description thereof is omitted.

In step S71, updating (replacing) a content file, attaching a comment to the content file, and revising the content file are executed by corresponding function programs of the encapsulated document 50 executed in Terminal B in accordance with instructions from User B. At this point, the manipulation logs of the respective manipulations are recorded in the manipulation log file 542 in the record folder 54 of the encapsulated document 50. The details of these operations are as described above.

In step S72, User B returns the encapsulated document 50 to User A (Terminal A) by, for example, attaching the encapsulated document 50 to an e-mail message. Then, in step S73, User A executes the encapsulated document 50 in Terminal A to check changes made by User B. Next, in step S74, User A gives an instruction to re-store the encapsulated document 50 from Terminal A through the GUI unit 13 of the encapsulated document management apparatus 10. In accordance with the instruction given by User A, the encapsulated document 50 is transmitted to the encapsulated document management apparatus 10 (step S75), and is re-stored therein by the management unit 12 (step S76).

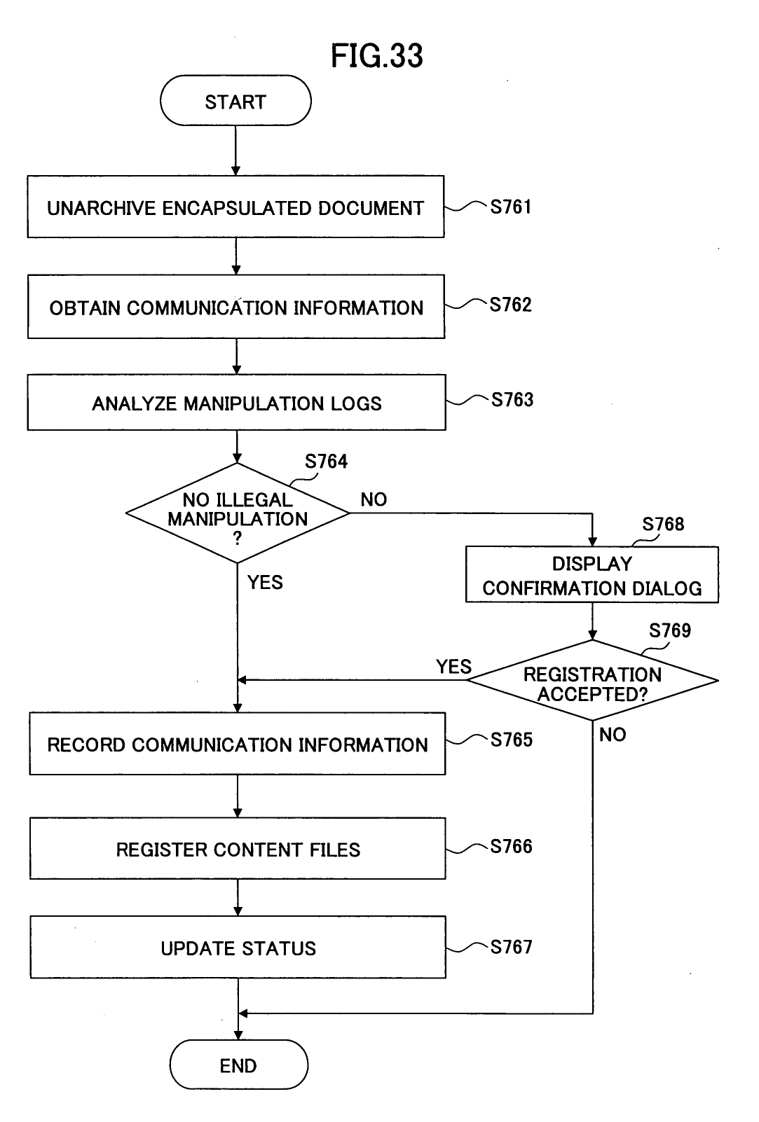

A description is given in more detail of the re-storing operation of step S76. FIG. 33 is a flowchart for illustrating re-storing of the encapsulated document 50.

First, in step S761, the management unit 12 unarchives the encapsulated document 50. Next, in step S762, the management unit 12 obtains the comment file 541 and the manipulation log file 542 from the record folder 54 of the encapsulated document 50. Then, in step S763, the management unit 12 analyzes the contents of the manipulation log file 542, and in step S754, determines whether the encapsulated document 50 has been illegally manipulated. Illegal manipulations are, for example, a manipulation by a user who is not authorized to access the encapsulated document 50 and a manipulation at a location (JP address) where accessing the encapsulated document 50 is prohibited. Users authorized to access the encapsulated document 50 and locations where accessing the encapsulated document 50 is authorized may be registered in the encapsulated document management DB 17 in advance, and authorization of access regarding users and locations may be determined based on the registered information.

If no illegal manipulation is detected (YES in step S764), in step S765, the management unit 12 records information recorded in the comment file 541 and the manipulation log file 542 (manipulation-related information or communication information) in the communication DB 17.

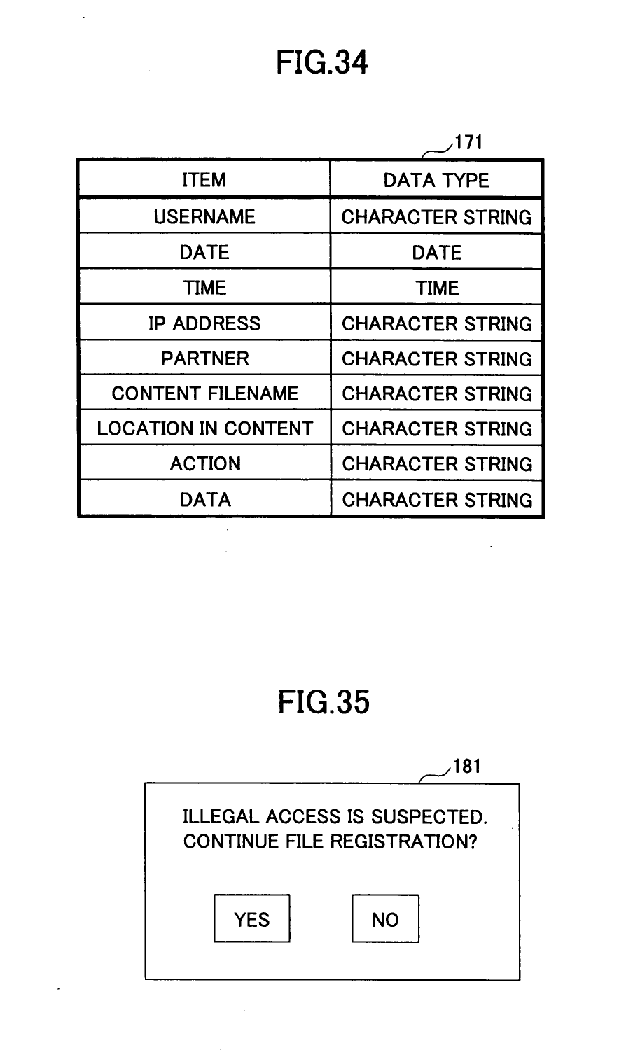

FIG. 34 is a diagram showing a configuration of a communication table forming the communication DB 17.

Referring to FIG. 34, a communication table 171 includes items such as Username, Date, Time, JP Address, Partner, Content Filename, Location in Content, Action, and Data. The values of the same item names recorded in the manipulation log file 542 are directly copied to the communication table 171 as the values of its items except for Data. Regarding Data, a filename in the encapsulated document management apparatus 10 is recorded. Specifically, for example, in the case of the comment file 541, a filename (including a pathname) at the time of storage of the comment file 541 in the encapsulated document management apparatus 10 is recorded.

Next, in step S766, the management unit 12 re-stores the content files contained in the content folder 52 of the encapsulated document 50 in the content DB 14. In this case, the versions of the content files may be managed in the content DB 14.

Next, in step S767, the management unit 12 sets the status of a record corresponding to the re-stored encapsulated document 50 to “returned” and records the date and time of the re-stored in Return Date and Time in the encapsulated document management table 161.

On the other hand, if an illegal manipulation is detected in step 8764 (NO in step S764), in step S768, the management unit 12 causes the GUI part 13 to display a dialog for confirming with a user whether to authorize registration of the encapsulated document 50.

FIG. 35 is a diagram showing an example display of the dialog for confirming whether to authorize registration of the encapsulated document 50.

Referring to FIG. 35, a dialog 181 displays a message: “Illegal access is suspected. Continue file registration!,” thereby notifying the user of possible illegal access and inquiring of the user whether to authorize continuation of registration.

If the user authorizes registration (YES in step S769), the management part 12 performs the above-described registration (steps S755 through S757). If the user denies registration (NO in step S769), the management unit 12 ends the operation without performing registration. If illegal access is detected, the operation may be forced to end without asking the user.

[Making Use of Communication Information]

As described above, information such as the creator, manipulation date and time, manipulation location (IP address), communication partner, manipulated content filename, and action (manipulation type) of the encapsulated document 50 is recorded as communication information (manipulation logs) between users via the encapsulated document 50 in the communication DB 17 of the encapsulated document management apparatus.

The management unit 12 provides the function of retrieving communication information using each of these items as a key. Further, when a request to search the content DB 14 is input through the GUI unit 13 by a user, the management unit 12, using the filename of a searched-out content file as a key, retrieves a manipulation log regarding the content file from the communication DB 17. The GUI unit 13 causes one or more manipulation logs retrieved based on the content file to be displayed on the display unit 106 together with the searched-out content file.

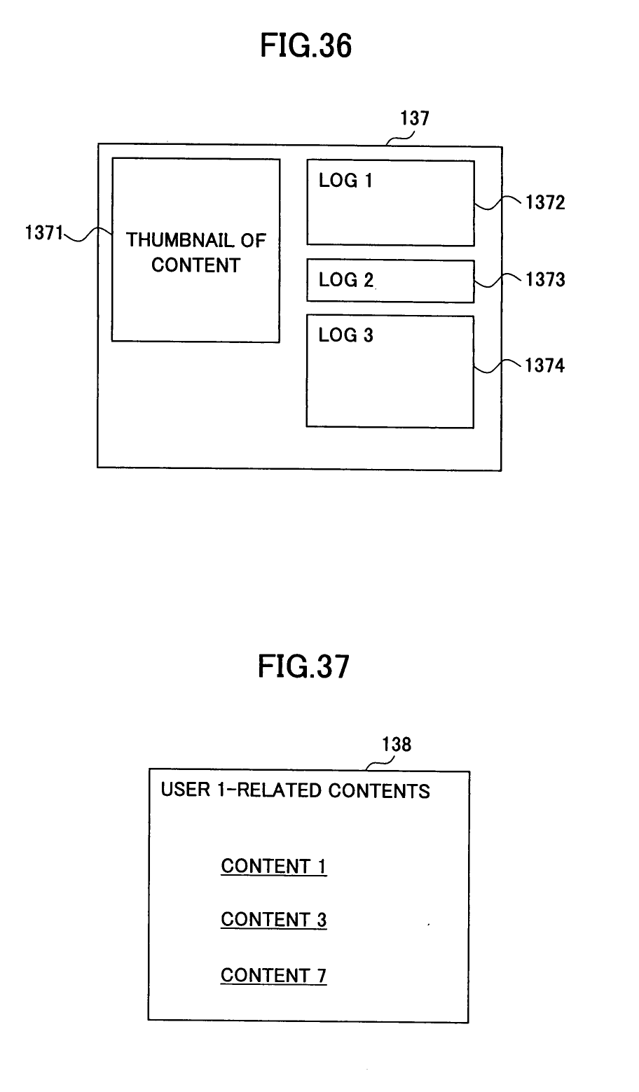

FIG. 36 is a diagram showing an example display of a content and its manipulation logs.

FIG. 36 shows the case where a thumbnail 1371 of a content file and manipulation logs 1372, 1373, and 1374 regarding the content file are displayed together on a screen 137. A user can be informed of or confirm reasons for updating the content and discussions held on the content by viewing the screen 137.

Further, when a username is input through the GUI part 13, the management unit 12 retrieves a manipulation log related to the username from the communication DB 17. Further, the management unit 12 causes the GUI unit 13 to display a list of target contents in the retrieved manipulation logs.

FIG. 37 is a diagram showing an example display of a list of content files regarding a user.

Referring to FIG. 37, the filenames of the content files manipulated by a user in the past are displayed in a list on a screen 138. Each filename is linked to the manipulation logs regarding its content file. Accordingly, when any of the filenames is operated on (for example, clicked), the GUI unit 13 causes the screen 137 shown in FIG. 36 to be displayed. The operation performed at this point is as described above with reference to FIG. 36. That is, the management unit 12, using the clicked filename as a key, retrieves a manipulation log regarding the corresponding content file from the communication DB 17.

As described above, according to the encapsulated document management apparatus 10 of this embodiment, it is possible to create the encapsulated document 50, and to accumulate communication information between users through the encapsulated document 50. The accumulated communication information (contents) do not form orderly minutes of proceedings, but direct exchanges between users remain. Accordingly, for example, a user who has not taken part in the communications can also easily see the reason why such a change or modification has been made. Further, this also has the merit of helping those concerned in the communications easily remember such a reason in retrospect. Nowadays, version management is often performed as a method of file management. However, each version is merely one result, and it is difficult to identify or confirm the reason why such a change has been made (resulted). However, this barrier can be lowered by accumulating the processes that have led to the change along with performing version management. Further, “why such a thing (change) has been done” can form know-how (knowledge), and by accumulating these, it is possible to construct a “know-how server” that stores more know-how, the more it is used.

According to one embodiment of the present invention, there is provided an apparatus for managing an encapsulated document, the apparatus including a file management part configured to manage one or more content files; a program management part configured to manage one or more programs for causing the content files to be manipulated; a document creation part configured to create the encapsulated document by storing a content file selected from the content files managed by the file management part and a program selected from the programs managed by the program management part in a single file; an extraction part configured to extract information on a manipulation by a user of the content file stored in the encapsulated document, the information being recorded in the encapsulated document by the program stored in the encapsulated document in accordance with the manipulation; and a manipulation information management part configured to manage the extracted information on the manipulation.

According to one embodiment of the present invention, there is provided a method of managing an encapsulated document executed by a computer, the method including a file management step of managing multiple content files; a program management step of managing multiple programs for causing the content files to be manipulated; a document creation step of creating the encapsulated document by storing a content file selected from the content files managed in the file management step and a program selected from the programs managed in the program management step in a single file; an extraction step of extracting information on a manipulation by a user of the content file stored in the encapsulated document, the information being recorded in the encapsulated document by the program stored in the encapsulated document in accordance with the manipulation; and a manipulation information management step of managing the extracted information on the manipulation.

According to the above-described apparatus and method for managing an encapsulated document, it is possible to manage an electronic document having a part for smoothing communications between users.

Thus, according to embodiments of the present invention, it is possible to provide an apparatus and method for managing an encapsulated document which apparatus and method are capable of appropriately managing an electronic document having a part for smoothing communications between users.

The present invention is not limited to the specifically disclosed embodiment, and variations and modifications may be made without departing from the scope of the present invention.

The present application is based on Japanese Priority Patent Application No. 2006-224522, filed on Aug. 21, 2006, the entire contents of which are hereby incorporated by reference.

What is claimed is:

1. An apparatus for managing an encapsulated document, comprising:
a file management unit to manage one or more content files;
a program management unit to manage one or more programs for causing the content files to be manipulated;
a document creation unit to create the encapsulated document by storing a content file selected from the content files managed by the file management unit and a program selected from the programs managed by the program management unit in a single file;
an extraction unit to extract information on a manipulation by a user of the content file stored in the encapsulated document, the information being recorded in the encapsulated document by the program stored in the encapsulated document in accordance with the manipulation; and
a manipulation information management unit configured to manage the extracted information on the manipulation.

2. The apparatus as claimed in claim 1, wherein:
the file management unit is operable to manage correlating information correlating each of the content files with a corresponding program for displaying or reproducing the content file; and
the creation unit is operable to store a program for displaying or reproducing the selected content file based on the correlating information of the selected content file.

3. The apparatus as claimed in claim 1, wherein at least a part of the information on the manipulation is comment information attached to the content file by the program in accordance with an input by the user.

4. The apparatus as claimed in claim 1, wherein at least a part of the information on the manipulation is history information of the manipulation recorded by the program in accordance with the manipulation by the user.

5. The apparatus as claimed in claim 1, further comprising:
a detection unit to detect an illegal manipulation of the encapsulated document based on the information on the manipulation extracted by the extraction unit.

6. The apparatus as claimed in claim 5, further comprising:
a content update unit to obtain the content file stored in the encapsulated document and update a corresponding one of the content files managed by the file management unit with the obtained content file,
wherein the content update unit is to update the corresponding one of the content files managed by the file management unit in response to the detection unit not detecting the illegal manipulation.

7. The apparatus as claimed in claim 1, wherein the manipulation information management unit is operable to further manage the information on the manipulation by the user on the content file stored in the encapsulated document, the information being transmitted from the program stored in the encapsulated document.

8. The apparatus as claimed in claim 7, wherein the manipulation information management unit is operable to manage the information on the manipulation by correlating the information on the manipulation with a corresponding one of the content files managed by the content file management unit.

9. A method of managing an encapsulated document executed by a computer, the method comprising:
managing one or more content files;
managing one or more programs for causing the content files to be manipulated;
creating the encapsulated document by storing a content file selected from the managed content files and a program selected from the managed programs in a single file;
extracting information on a manipulation by a user of the content file stored in the encapsulated document, the information being recorded in the encapsulated document by the program stored in the encapsulated document in accordance with the manipulation; and
managing the extracted information on the manipulation.

10. The method as claimed in claim 9, wherein:
managing the one or more file comprises managing correlating information correlating each of the content files with a corresponding program for displaying or reproducing the content file; and
creating the encapsulated document comprises storing a program for displaying or reproducing the selected content file based on the correlating information of the selected content file.

11. The method as claimed in claim 9, wherein at least a part of the information on the manipulation is comment information attached to the content file by the program in accordance with an input by the user.

12. The method as claimed in claim 9, wherein at least a part of the information on the manipulation is history information of the manipulation recorded by the program in accordance with the manipulation by the user.

13. The method as claimed in claim 9, further comprising:
detecting an illegal manipulation of the encapsulated document based on the extracted information.

14. The method as claimed in claim 13, further comprising:
obtaining the content file stored in the encapsulated document and updating a corresponding one of the managed content files with the obtained content file,
wherein obtaining the content file comprises updating the corresponding one of the managed content files in response to not detecting the illegal manipulation.

15. The method as claimed in claim 9, wherein managing the extracted information further comprises managing the information on the manipulation by the user on the content file stored in the encapsulated document, the information being transmitted from the program stored in the encapsulated document.

16. The method as claimed in claim 15, wherein managing the extracted information further comprises managing the information on the manipulation by correlating the information on the manipulation with a corresponding one of the managed content files.
